(19) United States
(12) Patent Application Publication
(10) Pub. No.: US 2007/0062086 A1
(43) Pub. Date: Mar. 22, 2007

(54) Sign made from standard sized print stock and a sign kit useful for making the same

(75) Inventors: Michael R. Hamel, Pickering (CA); Jerry G. Hodsdon, Forestdale, MA (US); Douglas W. Wilson, San Dimas (CA); Lynette B. Garcia, Burbank, CA (US); Thomas M. Wien, Newport Beach, CA (US)

Correspondence Address: INGRASSIA FISHER & LORENZ, P.C., 7150 E. CAMELBACK, STE. 325, SCOTTSDALE, AZ, 85251, US

(73) Assignee: Avery Dennison Corporation

(21) Appl. No.: 11/223,314

(22) Filed: Sep. 8, 2005

(51) Int. Cl. G09F 7/00

(52) U.S. Cl. 40/605; 40/607.03; 40/607.05

(57) ABSTRACT

A sign kit includes a plurality of print stock sheets, a substrate, and a support stake. The print stock sheets each include a face sheet and a backing sheet. The face sheet has an image surface configured to have an image imprinted thereon, and a back surface having a layer of adhesive applied thereto and a release coating adhered to the layer of adhesive. The substrate has a first side, a second side, and an outer peripheral edge between the first and second sides, and is adapted to have one or more of the print stock sheets adhesively and removably mounted thereon. Alignment indicia are disposed on at least the substrate first side. The alignment indicia are arranged to facilitate alignment of each adhesive backed sheet mounted on the substrate first surface. The support stake has a first end configured to be inserted into the substrate via the substrate outer peripheral edge, and a second end configured to insert into a support surface.

### TECHNICAL FIELD

The present invention relates to signs or posters and, more particularly, to an improved sign and sign kit that allows signs to be made from standard sized print stock.

### BACKGROUND

Signs and posters are commonly utilized for any number of reasons. For example, signs are used to announce a birthday, the arrival of a newborn baby, an outdoor event at a park, a meeting, and so on. In many cases, the sign or poster relatively large in size. That is, larger than a standard size piece of paper, such as, for example, A4, 8½×11 inches, or 11×14 inches. Accordingly, a person desiring to make a large-scale sign may have limited options. For example, the person may have the sign made professionally. However, this may involve an unacceptably high cost and a turn-around time.

Another available option may be to make the sign on a computer-connected SOHO (small-office, home-office) printer. To do so, the person prints out sections of the desired sign on a number of pieces of paper, and then couples the pieces of paper together or mounts the pieces of paper on a mount structure. This option also presents certain drawbacks. For example, many SOHO printers do not print over the entire extent of a sheet of paper (i.e., the edges of the paper are left blank), so the person may need to cut off the unprinted edges by hand and then assemble the remainder of the printed sheets together by abutting or overlapping them to form the sign. The assembled sheets may then taped or otherwise coupled together. This option may involve an unacceptable turn-around time, and may result in a sign that is not aesthetically pleasing.

Software is available that can manipulate images so that partial images may be printed on a SOHO printer, and then assembled by overlapping or abutting the individual sheets of stock. One specific example of a conventional approach to printing large-scale signs on general-use printers is disclosed in U.S. Pat. No. 6,187,405 to Rudin. The Rudin patent shows two embodiments. One of the embodiments utilizes a sheet with a central image area defined by die cuts. The central image area is printed upon so the image edges align with the die cuts. The central image area is then removed from the sheet to form a sign. In the other embodiment, a repositionable sheet has a strip of adhesive applied along a top edge and a bottom edge of the paper. The central image area is then printed upon and then removed from the sheet to form a sign. Without adhesive in a middle portion thereof, the central image area may be moved about when assembling a sign or a banner.

In both embodiments of the Rudin patent, a user positions a plurality of sheets in such a way that adjacent edges of abutting sheets are precisely aligned so that the graphic or image that is printed on the central image areas looks presentable. Moreover, the Rudin patent discusses an extensive and time-consuming test-printing process whereby the user manually adjusts the print margins of the image so that the edges of the image precisely align with the die cuts around the central image area of the sheets.

While the latter-described options may have cost advantages over professionally made signs, these too exhibit drawbacks. For example, a considerable amount of manual work may need to be employed to make the sign, particularly in ensuring that sheets are precisely printed, aligned, and butting up against each other in a side-to-side arrangement. If there is any printer misregistration or skewing that cannot be compensated for, the resulting images are likely to be misaligned when assembled. Moreover, if the printed image or graphic does not extend to the edges, then the user may need to “eyeball” or guess where to position adjacent sheets that form the sign. In addition, manual cutting of the unprinted edges may result in an imperfect sign with breaks or gaps in the text or image of the sign.

Accordingly, there is a need for an improved system that allows a user make a relatively large sign, poster, banner, or the like, using standard sized print stock. The present invention satisfies at least this need.

### BRIEF SUMMARY

The present invention provides an improved sign and sign kit that allows signs to be made from standard sized print stock.

In one embodiment, and by way of example only, a sign includes a substrate, alignment indicia, and a support stake. The substrate has a first side, a second side, and an outer peripheral edge between the first and second sides, and is adapted to have a plurality of printable sheets adhesively and removably mounted thereon. The alignment indicia are disposed on at least the substrate first side, and are arranged to facilitate alignment of the plurality of adhesive backed sheets on the substrate first surface. The support stake has a first end and a second end. The support stake first end is inserted into the substrate via the substrate outer peripheral edge, and the support stake second end is configured to insert into a support surface.

In another exemplary embodiment, a sign includes a substrate, a support stake, and a cover. The substrate has a first substantially planar surface, a second substantially planar surface, and an outer peripheral edge between the first and second substantially planar surfaces. At least the substrate first substantially planar surface is adapted to have a plurality of printable sheets adhesively and removably mounted thereon. The substrate outer peripheral edge defines at least a substrate top, a substrate bottom, a substrate left side, a substrate right side, and at least two rounded corners between the substrate top and the substrate left and right sides. The support stake has a first end and a second end. The support stake first end is inserted into the substrate via the substrate bottom, and the support stake second end is adapted to insert into a support surface. The cover is substantially transparent and is slidably disposed over and surrounds the substrate

In yet another exemplary embodiment, a kit for making a sign includes a plurality of print stock sheets, a substrate, and a support stake. The plurality of print stock sheets each include a face sheet and a backing sheet. The face sheet has an image surface configured to have an image imprinted thereon, and a back surface having a layer of adhesive applied thereto and a release coating adhered to the layer of adhesive. The substrate has a first side, a second side, and an outer peripheral edge between the first and second sides, and is adapted to have one or more of the print stock sheets adhesively and removably mounted thereon. Alignment indicia are disposed on at least the substrate first side. The alignment indicia are arranged to facilitate alignment of each adhesive backed sheet mounted on the substrate first surface. The support stake has a first end configured to be inserted into the substrate via the substrate outer peripheral edge, and a second end configured to insert into a support surface.

Another inventive embodiment includes package for enclosing the sign and/or the sign kit.

Other features and advantages of the sign and sign kit will become apparent from the following detailed description taken in conjunction with the accompanying drawings.

### BRIEF DESCRIPTION OF THE DRAWINGS

FIG. 1 illustrates a computer and printer system for making a sign with a plurality of sheets of printing stock;

FIG. 2 is a perspective view of a sign with a composite image made according to a number of embodiments;

FIG. 3 is a plan view of a face sheet of a sheet of printing stock with a sub-image printed thereon according to a number of embodiments;

FIG. 4 is a view similar to FIG. 3 with a face sub-sheet peeled away to expose a portion of an adhesive surface thereof;

FIG. 5 is a cross-sectional view taken along line 5-5 of FIG. 3;

FIG. 6 is a plan view of a face sheet of a sheet of printing stock with a sub-image printed thereon according to a number of other embodiments;

FIG. 7 is a cross-sectional view taken along line 7-7 of FIG. 6;

FIG. 8 is a plan view of a backing sheet of the sheet of printing stock of FIG. 6;

FIG. 9 is a view similar to FIG. 6 with a combination of a margin and a border removed;

FIG. 10 is a cross-sectional view taken along line 10-10 of FIG. 9;

FIG. 11 is a plan view of the sheet of FIG. 9 aligned with a sheet of printing stock with a corresponding sub-image;

FIG. 12 is a view similar to FIG. 11 with the two sheets adhered together;

FIG. 13 is a plan view of a face sheet of a sheet of printing stock with a sub-image printed thereon according to a number of still other embodiments;

FIG. 14 is a view similar to FIG. 13 illustrating a face sub-sheet removed from the sheet of printing stock and adhered to a surface;

FIG. 15 is an enlarged fragmentary view of a corner of a sheet of printing stock with registration marks according to some of the embodiments;

FIG. 16 is a view similar to FIG. 14 illustrating another sheet being align with a sheet already adhered to a surface;

FIG. 17 is a view similar to FIG. 16 illustrating the two sheets align and adhered to the surface;

FIG. 18 is an enlarged fragmentary view of a corner of a sheet of printing stock with registration marks according to other embodiments;

FIG. 19 is an enlarged fragmentary view of a corner of a sheet of printing stock with registration marks according to still other embodiments;

FIG. 20 is a flow chart illustrating manufacturing methodology according to a number of embodiments;

FIG. 21 is a perspective view of a roll of uncut printing stock;

FIG. 22 is a plan view of a sheet of printing stock according to a number of still other embodiments;

FIG. 23 is a plan view of a sheet of printing stock according to still other embodiments;

FIG. 24 is a cross-sectional view of a projection of a backing sub-sheet peeling away from a face sub-sheet;

FIG. 25 is a plan view of a front side of a sheet of printing stock according to still further embodiments;

FIG. 26 is a plan view of a back side of the sheet of FIG. 25;

FIGS. 27A-27H illustrate methodology for applying a face sub-sheet of the sheet of printing stock shown in FIGS. 25 and 26 to a surface according to some of the embodiments;

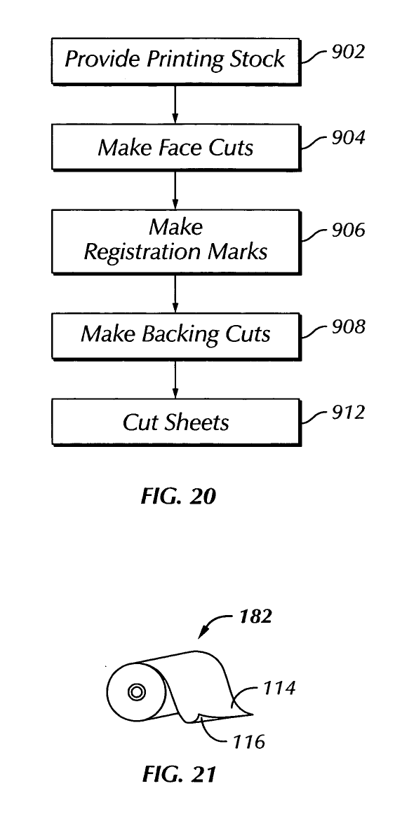

FIG. 20D′ is a plan view of a back side of the readily adherent face sub-sheet shown in FIG. 20D;

FIG. 28 is a plan view of a front side of a sheet of printing stock according to still other embodiments;

FIG. 29 is a plan view of a back side of the sheet of printing stock of FIG. 28;

FIG. 30 is an enlarged fragmentary view of a tab section of a backing sub-sheet of the sheet of printing stock of FIGS. 28 and 29;

FIGS. 31A-31H illustrate methodology for applying a face sub-sheet of the sheet of printing stock shown in FIGS. 28 and 29 to a surface according to some of the embodiments;

FIG. 31D′ is a plan view of a back side of the readily adherent face sub-sheet shown in FIG. 31D;

FIG. 32 is a plan view of a front side of a sheet of printing stock according to still further embodiments;

FIG. 33 is an enlarged fragmentary view of a corner of the sheet of printing stock of FIG. 32 showing registration marks;

FIG. 34 is a plan view of a front side of a sheet of printing stock according to other embodiments;

FIG. 35 is an enlarged fragmentary view of a corner of the sheet of printing stock of FIG. 34 showing registration marks;

FIG. 36 is a plan view of a front side of a sheet of printing stock according to still more embodiments;

FIG. 37 is an enlarged fragmentary view of a corner of the sheet of printing stock of FIG. 36 showing registration marks;

FIG. 38 is a plan view of a front side of a sheet of printing stock according to a number of embodiments;

FIG. 39 is a plan view of a back side of a readily adherent sheet of printing stock illustrating exposed adhesive portions;

FIG. 40 is a fragmentary cross-sectional view of the readily adherent sheet of FIG. 39;

FIG. 41 is a plan view of a front side of a sheet of printing stock according to further embodiments;

FIG. 42 is a plan view of a front side of a sheet of printing stock according to still further embodiments;

FIG. 43 is a plan view of a back side of a readily adherent sheet removed from the sheet of print stock of FIG. 42;

FIG. 44 shows an embodiment of a kit that may be used make the sign illustrated in FIG. 2;

FIG. 45 is an end view of a substrate that forms part of the exemplary kit shown in FIG. 44;

FIG. 46 illustrates a fully-assembled sign made using the kit of FIG. 44;

FIG. 47 shows a plastic sheet that may be used to form a cover for the sign shown in FIG. 46;

FIGS. 48 and 49 illustrate an exemplary assembly method for the cover included in the kit of FIG. 44;

FIG. 50 is a flowchart depicting an exemplary process for making a sign using the kit illustrated in FIG. 44;

FIG. 51 is a block diagram illustrating a computer and printer system for processing and printing an image according to a number of embodiments;

FIG. 52 is a flow chart schematically illustrating a software engine according to a number of embodiments

FIGS. 53, 54, and 55 illustrate signs characterized by verticality, horizontality, and rectangularity, respectively; and

FIGS. 56-58 depict an exemplary embodiment of a package that may be used to package the kit of FIG. 44.

### DETAILED DESCRIPTION OF PREFERRED EMBODIMENTS

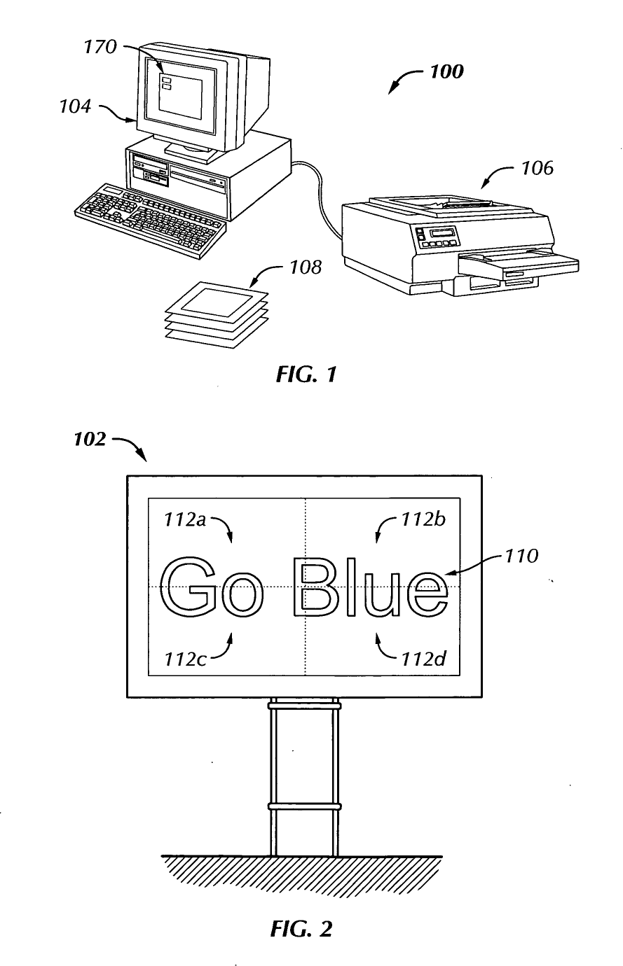

Referring now to FIGS. 1 and 2, a system 100 for printing a sign 102, and an embodiment of the sign 102 are shown, respectively. The system 100 includes a computer 104, a printer 106, and a plurality of sheets 108 of printing stock. The system 100 may be utilized when it is desired to print a large sign—that is, a sign larger than a single standard-sized sheet of paper (e.g., A4, 8½×11 inches, 11×14 inches, etc.)—with a standard small-office, home-office (SOHO) or home printer 106 such as, for example, an inkjet printer or a laser printer. The sign 102 includes a printed composite image 110. The printed composite image 110 is made from a plurality of printed sub-images 112a, 112b, 112c, and 112d, with each of the sub-images 112 including a portion of the composite image 110. Although only four sub-images 112 are shown, it will be appreciated that the sign 102 could be made using more or less than this number of sub-images 112. A more detailed description of various embodiments of the sign 102, a kit used to make the sign 102, and methods for making the sign 102, will be provided further below. Before doing so, however, detailed descriptions of various embodiments of the sheets 108 of printing stock will first be described.

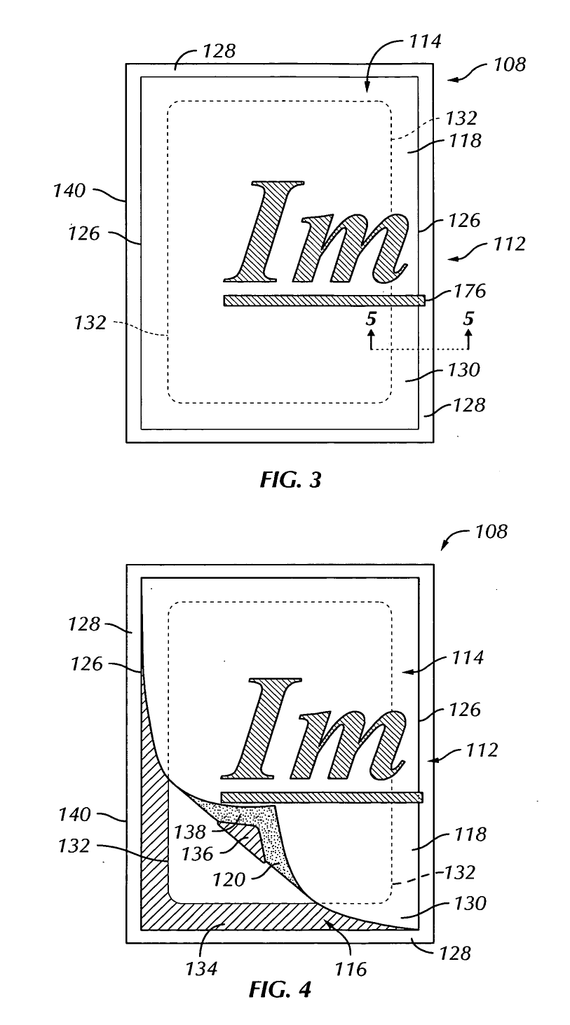

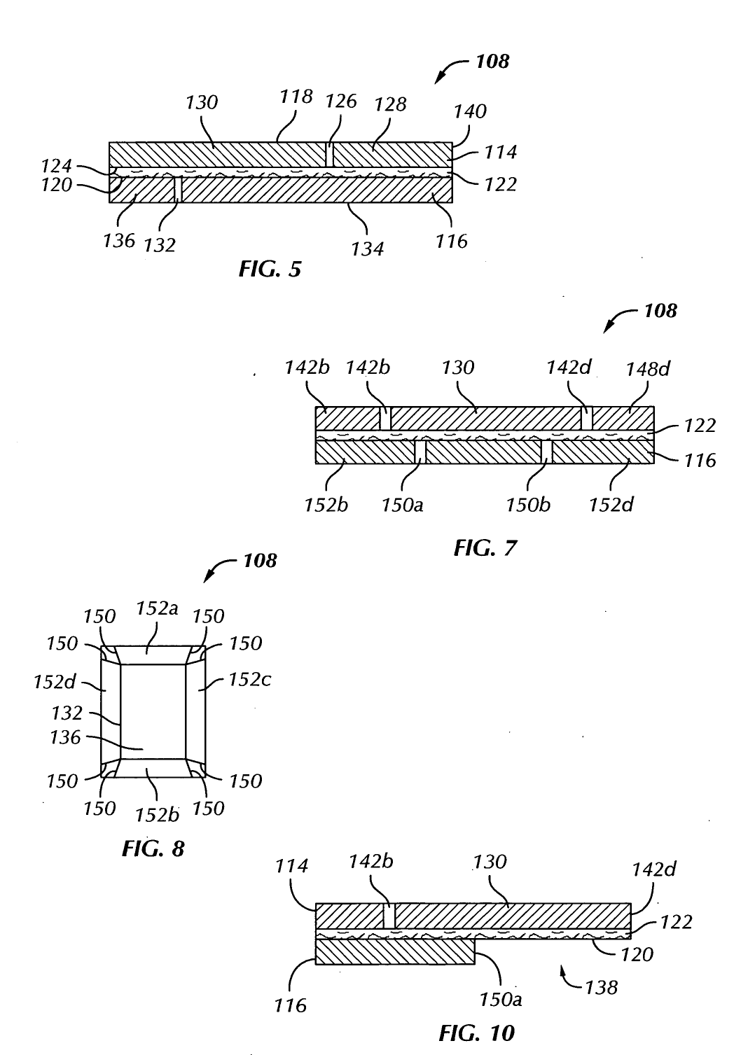

Turning now to FIGS. 3, 4, and 5, each sheet 108 of printing stock includes a face sheet 114 and a backing sheet 116. The face sheet 114 includes a printing surface 118 for receiving ink and an adhesive surface 120 for receiving the backing sheet 116. The adhesive surface 120 is particularly shown in FIG. 4. In some of embodiments, the adhesive surface 120 of the face sheet 108 includes a layer of adhesive 122 applied to a back surface 124 of the face sheet 114 as shown in FIG. 5. As known in the art, the backing sheet 116 includes a release agent (not shown) coated on the side adherent to the adhesive surface 120 of the face sheet 108 to provide a suitable adhesive bond between the backing sheet 116 and the face sheet 114.

The face sheet 114 may also include a face cut 126 that forms or defines a margin 128 and a face sub-sheet 130. The face cut 126 is formed in the face sheet 114 such that the face sub-sheet 130 is separable from the margin 128, as particularly shown in FIG. 4. That is, the face sub-sheet 130 may be removed from the sheet 108 of printing stock. The face cut 126 includes a die cut formed through the face sheet 114 as shown in FIG. 5. Alternatively, the face cut 126 includes perforations, such as microperforations.

According to a number of embodiments, the backing sheet 116 includes a backing cut 132, which is shown in phantom line in FIGS. 3 and 4, that forms or defines a border 134 and a backing sub-sheet 136, which are shown in FIGS. 4 and 5. The backing cut 132 is formed in the backing sheet 116 such that the backing sub-sheet 136 is separable from the border 134 as shown in FIG. 4. In some of the embodiments, the backing sub-sheet 136 is removed from the sheet 108 of printing stock when the face sub-sheet 130 is removed from the sheet 108 by remaining adhered to the adhesive surface 120 of the face sub-sheet 130.

In the embodiment shown in FIGS. 3-5, the face cut 126 may be positioned in the face sheet 114 such that when the face sub-sheet 130 is separated from the margin 128, a portion of the adhesive surface 120 is exposed, which portion is indicated by reference numeral 138 in FIG. 4. For example, the face cut 126 may be spatially positioned between the backing cut 132 and a perimeter 140 of the face sheet 114 and the backing sheet 116. Also in the embodiment shown, the face cut 126 may be generally rectilinear such that the face sub-sheet 130 is rectangular.

In some of the embodiments, the face cut 126 and the backing cut 132 may be substantially concentric about a central region of the sheet 108 of printing stock. As a specific example for a standard-sized sheet 108 of printing stock (e.g., 8½×11 inches), the face cut 126 may be positioned equidistantly about three-eighths of an inch or so from the perimeter 140, which the backing cut 132 may be positioned equidistantly about one inch or so from the perimeter 140.

As is generally known in the art, one of the effects of removing an adhesive label from a release liner or backing sheet is that the act of removing the label may cause the label to curl. That is, the label may bend where the adhesive is in the process of being separated from the liner. The result is similar to pulling a piece of paper with tension over an edge of a desk. Typically, the greater the adhesive strength, the greater the removal angle, or the thinner the label, the greater the curl will be. However, one of the advantages of this embodiment is that curl is reduced or eliminated. More specifically, as only a portion 138 of the adhesive surface 120 is exposed, less force is required to remove the face sub-sheet 130. In addition, the presence of the backing sub-sheet 136 renders the removed face sub-sheet 120 as a two-layer construction with greater stiffness, thereby bending less during and after removal from the margin 128 and the border 134. The removal of backing sub-sheet 136 also causes less of the face sub-sheet 130 to be separated from the border 134 of the backing sheet 116.

According to other embodiments, such as shown in FIGS. 6 and 7, the face cut 126 includes four edge cuts 142. For the purposes of this description, the face sheet 114 and the backing sheet 116 each has (or collectively have) a top edge 144a, a bottom edge 144b, and two side edges 144c and 144d, with respective pairs of the edges 144 intersecting at four corners 146a, 146b, 146c, and 146d. The edge cuts 142 may each extend between a respective pair of opposing edges 144 at a distance from a respective one of the edges. Accordingly, in these embodiments, the edge cuts 142 divide the margin 128 into a plurality of margin segments 148a, 148b, 148c, and 148d, with each margin segment 148 being individually separable from the other margin segments 148. In other words, at least a portion of the margin 128 may be selectively separated from the other portions of the margin 128.

More specifically, in the embodiment shown, edge cut 142a extends between the side edges 144c and 144d at a distance from the top edge 144a, thereby defining margin segment 148a; edge cut 142b extends between the side edges 144c and 144d at a distance from the bottom edge 144b, thereby defining margin segment 148b; edge cut 142c extends between the top edge 144a and the bottom edge 144b at a distance from the left side edge 144c, thereby defining margin segment 148c; and edge cut 142d extends between the top edge 144a and the bottom edge 144b at a distance from the right side edge 144d, thereby defining margin segment 148d.

In some of the embodiments, the backing sheet 116 includes a plurality of pairs of corner cuts 150a and 150b, with each of the corner cuts 150 extending from the backing cut 132 to a respective one of the edges 144 of the backing sheet 116, which are shown in phantom line in FIG. 6. Accordingly, in these embodiments, the corner cuts 150 divide the border 134 into a plurality of border segments 152a, 152b, 152c, and 152d, which are particularly shown in FIG. 8, with each border segment 152 being individually separable from the other border segments 152. In other words, at least a portion of the border 134 may be selectively separated from the other portions of the border 134.

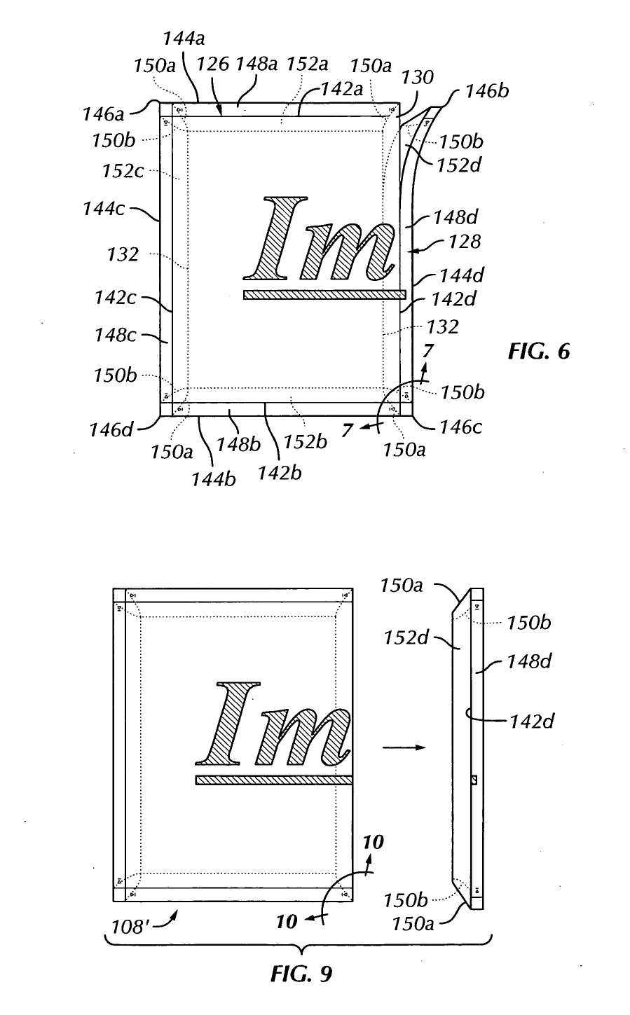

To remove one of the border segments 152, such as border segment 152d as shown in FIGS. 6 and 9, border segment 152a is peeled rearward away along corner cut 150a at corner 146b, the backing cut 132 along edge 144d, and corner cut 150a at corner 146c. Margin segment 148d also peels away from the face sub-sheet 130 along edge cut 142d. The combination of margin segment 148d and border segment 152d is then separated from the remainder of the sheet 108 of printing stock as shown in FIG. 9, thereby leaving a portion of the adhesive surface 120 exposed, which portion is indicated by reference numeral 138 in FIG. 10. The removal of the combination of margin segment 148d and border segment 152 from the sheet 108 of printing stock yields a readily adherent sheet of printing stock, which is indicated by reference number 108′ in FIG. 9.

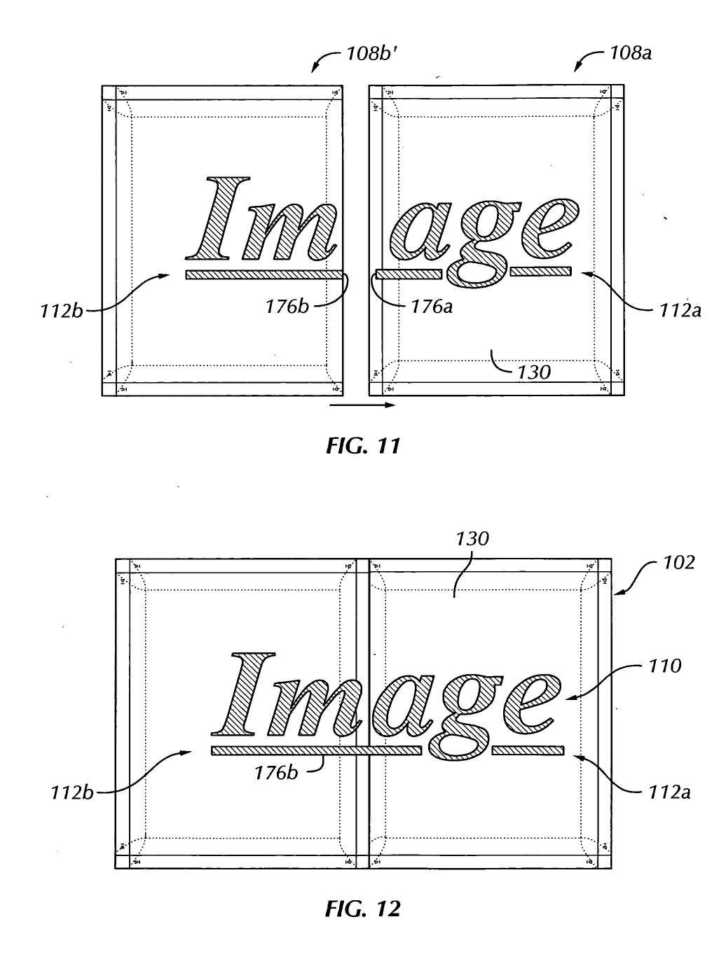

The sheets 108 of printing stock configured according to the embodiment shown in FIGS. 6-10 may be utilized in making a sign 102 that does not require adhesion to a surface to which the face sub-sheets 130 are adhered. More specifically, with reference to FIGS. 11 and 12, a sheet 108a of printing stock with sub-image 112a printed on the face sheet 130 thereof has not had any of the margin segments 148 or the border segments 152 removed and, accordingly, has not had any portion of the adhesive surface 120 exposed. A readily adherent sheet 108b′ of printing stock with sub-image 112b printed on the face sheet 130 thereof may then be adhered to the face sheet 130 of non-adherent sheet 108a so that the desired printed composite image 110 is formed. Sheet 108b′ may be positioned on sheet 108a such that the exposed portion 138 of the adhesive surface of sheet 108b′ is coextensive with a corresponding portion of the face sheet 130 of sheet 108a. Accordingly, the resulting sign 102 does not have any exposed portions of adhesive surface.

Another one of the advantages of the embodiment shown in FIGS. 6-12 is that the sign 102 may be adhered to a surface after assembly if desired. For example, a portion of the border segment 152 may be removed to expose a portion 138 of the adhesive surface 120. Alternatively, all of the border segments 152 along the perimeter of the sign 102 may be removed for adhering to a surface. Still alternatively, all of the backing sheet 116 may be removed from the sign 102 to expose the entire adhesive surface 120.

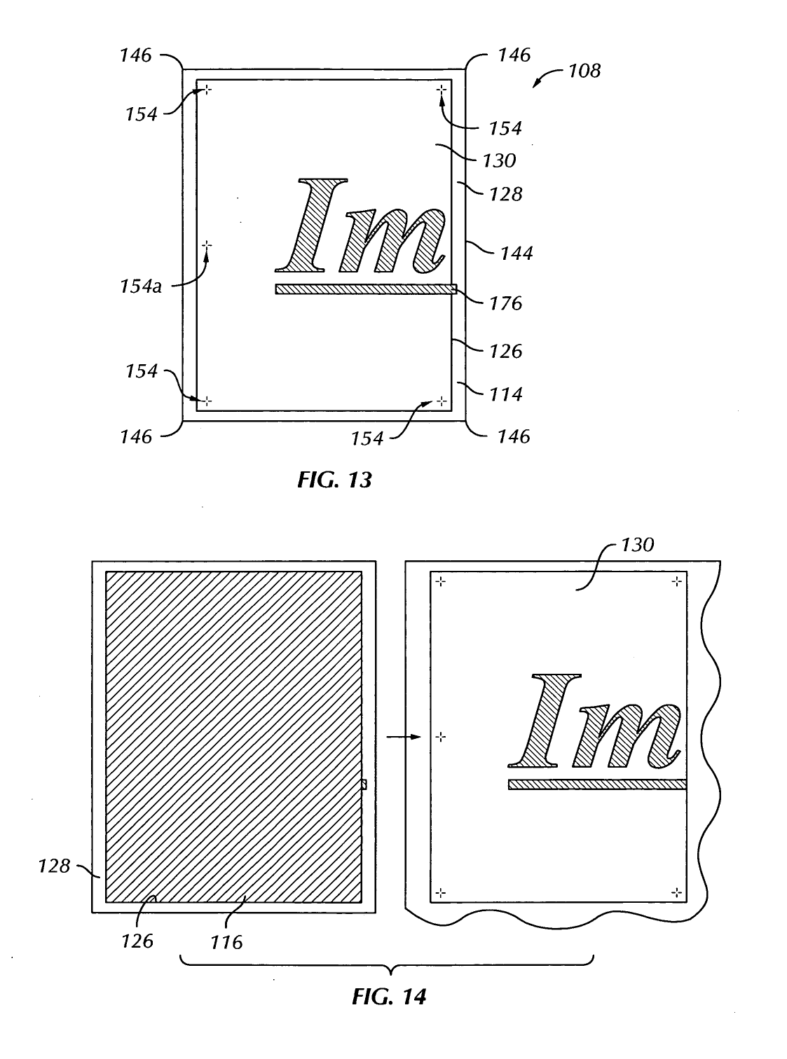

According to still other embodiments, such as shown in FIGS. 13 and 14, the face sheet 114 includes a face cut 126, while the backing sheet 116 is free of any backing cut. Accordingly, when removed from the sheet 108 of printing stock, the face sub-sheet 130 is separated from the entire backing sheet 116 and the margin 128 as shown in FIG. 14, with the entire extent of the adhesive surface 120 of the face sub-sheet 130 being exposed. In a number of embodiments, the face sheet 114 includes one or more registration marks 154 that may be utilized in assembling the plurality of sheets 108 of printing stock that have been printed on to form the sign 102.

For example, with reference to FIGS. 13, 14, and 15, the face sheet 114 includes a plurality of registration marks 154. In the embodiments shown in these figures, the registration marks 154 may be disposed at or near each of the four corners 146 of the face sheet 114. In other embodiments, the registration marks 154 may be disposed near the face cut 126 and any location along the extent thereof, for example, as indicated by reference numeral 154a in FIG. 13. One of the advantages of utilizing registration marks 154 is that a user is enabled to quickly and accurately arrange, position, or align adjacent sub-sheets 130 to form a sign, which is discussed in more detail below. This is particularly useful when the printed image or graphic does not extend all the way to the edge of the sub-sheet 130, in that a user may utilize the registration marks 154 to align adjacent sub-sheets 130.

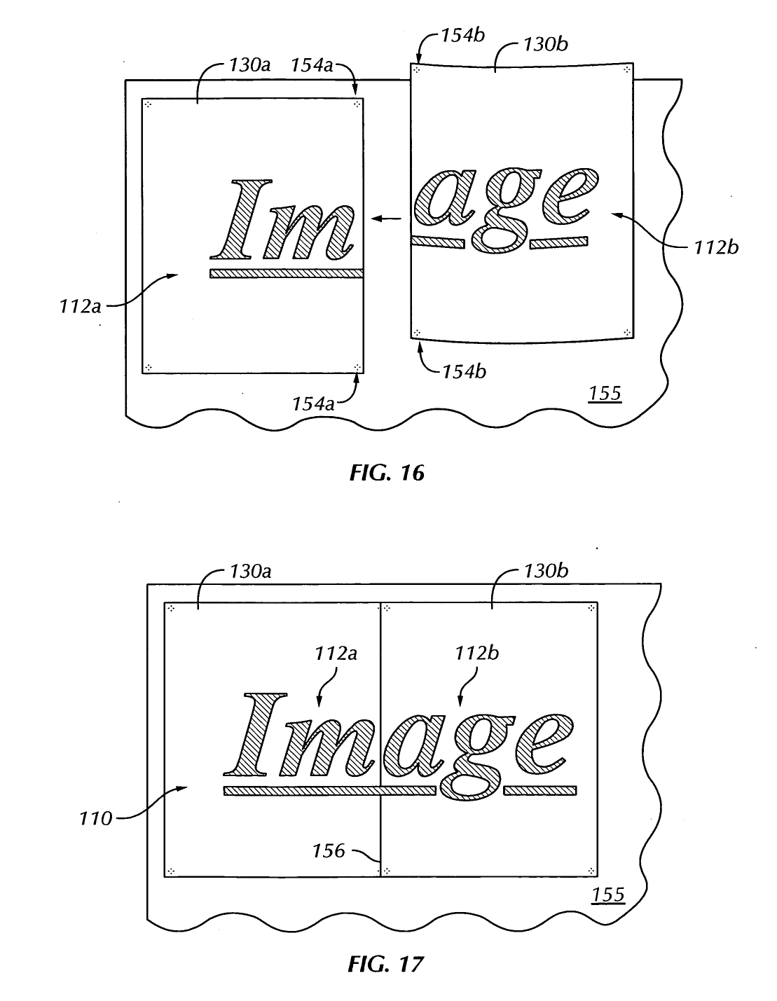

As mentioned, the registration marks 154 may be used during the assembly of the sign 102. More specifically, the registration marks 154 may aid, guide, or enable the face sub-sheet 130 from one of the sheets 108 of printing stock that is separated from the margin 128 thereof to be positioned on a surface with respect to a face sub-sheet 130 from another one of the sheets 108 of printing stock that is already adhered to the surface. For example, as shown in FIG. 16, a face sub-sheet 130a with a printed sub-image 112a is adhered to a surface 155. A subsequent face sub-sheet 130b with a complementary printed sub-image 112b may then be positioned adjacent to, coextensively or overlapping along a common edge with, or in an otherwise composite relationship with the already adhered face sub-sheet 130a, with the subsequent face sub-sheet 130b then being adhered to the surface 155, such that the desired printed composite image 110 is formed, as shown in FIG. 17.

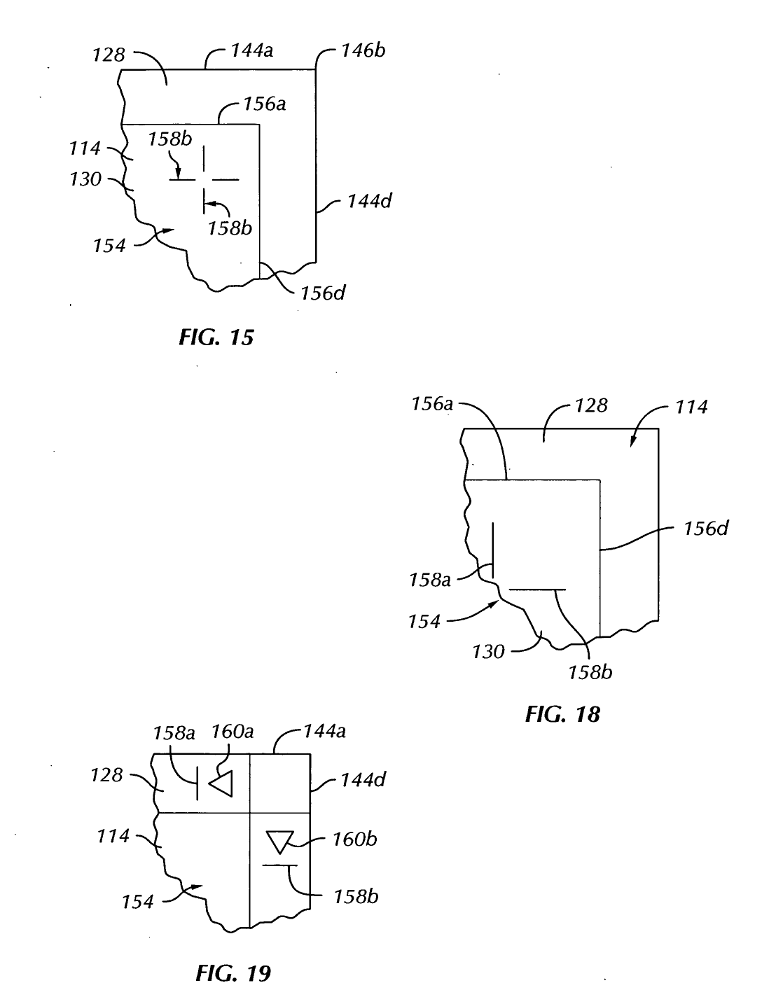

This desired or predetermined position may be attained by aligning an edge 156 of the subsequently adhered face sub-sheet 130b with the registration marks 154a of the already adhered face sub-sheet 130a. Thereafter, adjustments may be made if needed to further align the printed image or text to compensate as needed for printer variation, mis-registration, and/or skewing. In this regard, in some of the embodiments, the registration marks 154 includes one or more alignment elements 158 respectively disposed substantially parallel to one of the edges 144 of the face sheet 114 or one of the edges 156 of the face sub-sheet 130, which is particularly shown in FIGS. 15 and 18. For example, alignment mark 158a is substantially parallel to edge 156d of the face sub-sheet 130 (and edge 144d of the face sheet 114), and alignment mark 158b is substantially parallel to edge 156a of the face sub-sheet 130 (and edge 144a of the face sheet 114). Accordingly, as represented in FIGS. 16 and 17, the registration marks 154 enable a face sub-sheet 130b that is to be subsequently positioned to be overlapped on top of an already positioned face sub-sheet 130a, and then to be moved to make adjustments as needed to more properly align the image 112 to compensate for minor mis-registration or skewing.

In some of the embodiments, the registration marks 154 includes a pair of alignment elements 158, such as shown in FIG. 18. In other embodiments, the registration marks 154 includes a plurality of alignment elements 158 disposed in a cross-hair pattern, such as shown in FIG. 15. In still other embodiments, such as shown in FIG. 19, the registration marks 154 includes a directional element 160a and 160b disposed near a respective one the alignment elements 158a and 158b, with the direction elements 160 indicating a directional positioning of a subsequently adhered face sub-sheet 130.

As shown in the embodiments in FIGS. 15 and 18, the registration marks 154 may be disposed on the face sub-sheet 130 of the face sheet 114. Alternatively, as shown in FIG. 19, the registration marks 154 may be disposed on the margin 128 of the face sheet 114. In some of the embodiments, the alignment elements 158 may be disposed equidistantly from a respective pair of edges 156 (or 144) at one of the corners 146 (e.g., alignment elements 158a and 158b disposed equidistantly from edges 156d and 156a at corner 146b). In addition, the registration marks 154 includes perforations or may be die cut into the face sheet 114. Alternatively, the registration marks 154 may be applied to the printing surface 118 when the sub-image 112 is applied to the printing surface 118, which will be discussed in more detail below.

With reference now to FIG. 20, from a production standpoint, the sheets 108 of printing stock may be manufactured by first providing uncut printing stock (step S1120), such as a roll of printing stock 182, as shown in FIG. 21, including a continuous face sheet 114 and backing sheet 116. A plurality of face cuts 126 may then be made through the face sheet 114 (step S122) to form a plurality of the margins 128 and a corresponding plurality of the face sub-sheets 130. A plurality of backing cuts 132 may then be made through the backing sheet 116 (step S124) to form a plurality of the borders 134 and a corresponding plurality of the backing sub-sheets 136. In addition, a plurality of registration marks 154 may be made (step S126). In embodiments in which the registration marks are die cut, the registration marks 154 may be made at the same time the face cuts 126 are made (i.e., at step S122). The printing stock may then be cut into the sheets 108 of printing stock (step S128) such that each of the sheets 108 of printing stock includes a face cut and a backing cut. As mentioned, in a number of embodiments, the sheets 108 are cut into standard sizes (e.g., A4, 8½×11 inches, and legal size) to be receivable through a SOHO printer.

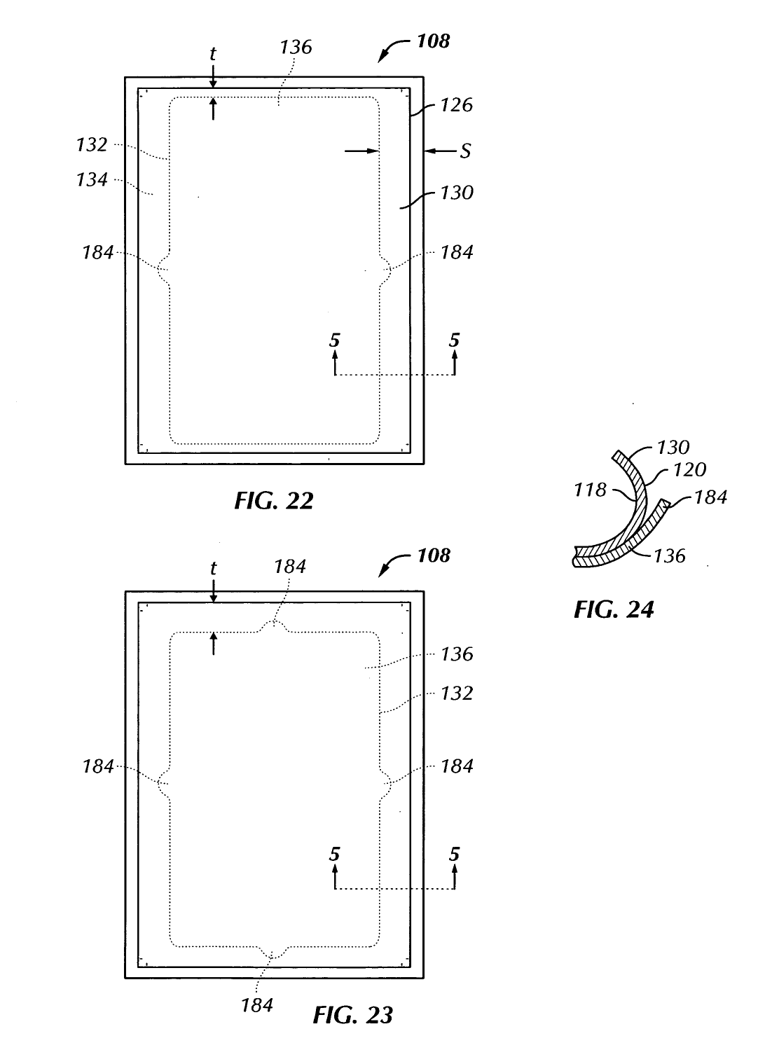

Additional embodiments of sheets 108 of printing stock are illustrated in FIGS. 28A and 29. In the embodiments shown therein, the sheet 108 includes a backing cut 132 in the backing sheet 116 (see FIG. 5) such that a backing sub-sheet 136 includes one or more projections 184. As shown in the embodiment of FIG. 22, one projection 184 may be formed in each opposing side of the backing sub-sheet 136. Alternatively, as shown in the embodiment of FIG. 23, one projection 184 may be formed in each of the four sides of the backing sub-sheet 136. The projections 184 may be semi-circular as shown, or may be oval, elliptical, rectilinear, free form, or any other shape.

When assembling a sign 102 with the border 134 removed from the backing sheet 116, the face sub-sheet 130 with the backing sub-sheet 136 may be positioned on a surface 155 (see, e.g., FIG. 16) and aligned with one or more sheets already in place on the surface if such sheets are present. The exposed adhesive portion 138 (see, e.g., FIG. 4) along one side (e.g., the left side) may be adhered to both the adjoining already-mounted face sub-sheet 130 and the surface 155.

With reference to FIG. 24, the unadhered opposing side (e.g., the right side) may then be bent back toward the face sub-sheet 130. Because of the stiffness of the backing sub-sheet 136 and the strength adhesive bond between the adhesive surface 120 and the backing sub-sheet 136, the projection 184 may separate from the adhesive surface 120 of the face sub-sheet 130 as shown in FIG. 24, thereby providing a finger tab for grasping to facilitate the removal of the backing sub-sheet 136. In addition to this feature, the projections 184 may further provide a visual cue to a user to remove the backing sub-sheet 136 prior to adhering the entire exposed adhesive portion 138 to the surface.

With continued reference to FIGS. 22 and 23, the backing cut 132 may be made in the backing sheet 116 so that a relatively narrow border 134 is defined in the backing sub-sheet 116 along one or more sides, for example, a top and bottom side as shown in FIG. 22. In this regard, a relatively narrow exposed portion 138 of the adhesive surface 120 results when the border 134 is removed, as indicated by reference alpha t in these two figures, with a relatively small or narrow exposed portion 138 resulting from the embodiment shown in FIG. 22, in comparison to a relatively large exposed portion resulting from the embodiment shown in FIG. 23. The narrow exposed portion 138 is preferably defined along the shorter sides, namely, the top and bottom sides, so that it is easier to fold back the face sub-sheet 130 to remove the backing sub-sheet 136. Alternatively, the sheet 108 includes an asymmetrical backing sub-sheet 136 so that only a single narrowed exposed portion 138 is defined along one of the sides. In some of the embodiments, the relatively narrow portion t indicated in FIG. 21 may be on the order of less than about one inch.

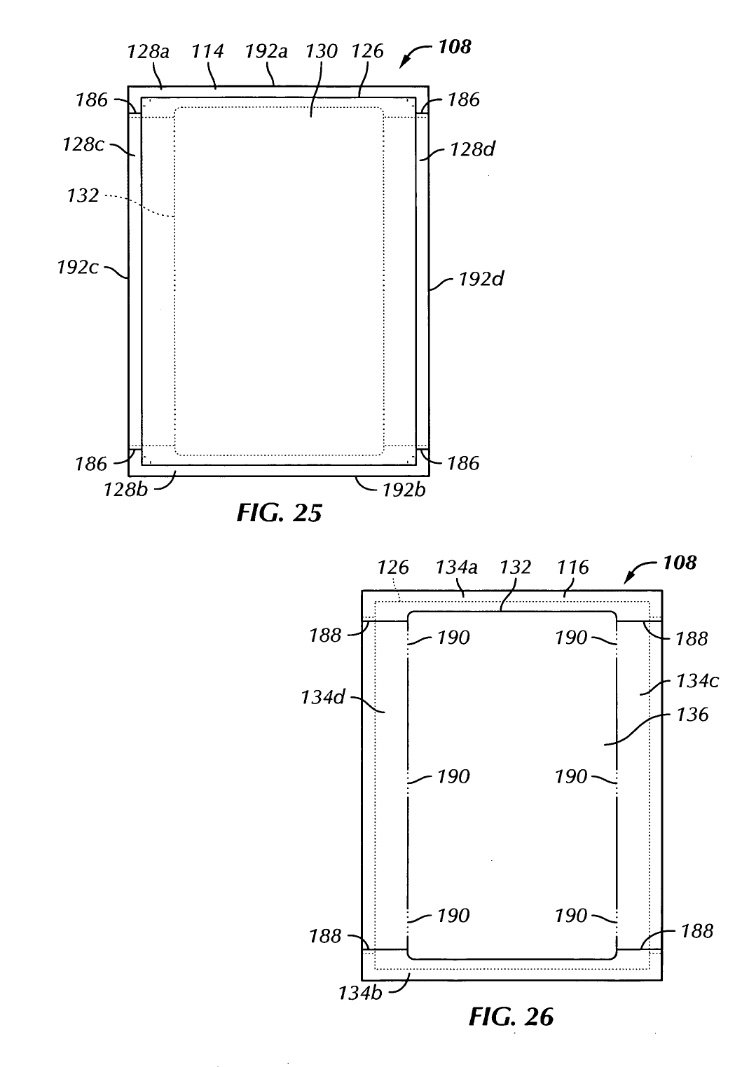

With reference to FIG. 25, in still other embodiments a sheet 108 of printing stock includes a face sheet 114 with a primary face cut 126 defining the face sub-sheet 130 and one or more secondary face cuts 186 formed through the margin 128 between the primary face cut 126 and an outer edge of the face sheet 114. In some of the embodiments, the secondary face cuts 186 may be formed near the corners of the face sheet 114, for example, positioned in the left and right margins 128 and spaced from the top and bottom edges by less than a few inches. The secondary face cuts 186 may be continuous cuts or, alternatively, may be perforated. The secondary face cuts 186 may be described as defining a top margin 128a, a bottom margin 128b, a left margin 128c, and a right margin 128d.

As shown in FIG. 26, the backing sheet 116 includes a primary backing cut 132 defining the backing sub-sheet 136 and one or more secondary backing cuts 188 formed through the border 134 between the primary backing cut 132 and an outer edge of the backing sheet 116. In some of the embodiments, the secondary backing cuts 188 may be formed near the corners of the backing sheet 116, for example, positioned in the left and right borders 134 and spaced from the top and bottom edges by less than a few inches. The secondary backing cuts 188 may be continuous cuts or perforated. The secondary backing cuts 188 may be described as defining a top border 134a, a bottom border 134b, a left board 134c, and a right border 134d.

Returning now to FIG. 25, and as will be described in more detail below, the margins 128 and the borders 134 define in the sheet 108 a top section 192a (including the top margin 128a and the top border 128b), a bottom section (including the bottom margin 128b and the bottom border 134b), a left side section 192c (including the left margin 128c and the left border 128c), and a right side section 192d (including the right margin 128d and the right border 134d).

In a number of embodiments, the primary face cut 132 may additionally include a plurality of perforated sections 190, indicated in FIG. 26 using dashed line. The perforated sections 190 may be positioned along at least two of the four portions (i.e., top, bottom, left, and right) of the primary backing cut 132, for example, along the left portion and the right portion of the primary backing cut 132 as shown. Also as shown, the primary backing cut 132 includes three perforated sections 190 per side and spaced substantially equidistantly. The perforated sections 190 may be described as providing a weakened bond between the backing sub-sheet 136 and the border 134 of the backing sheet 116.

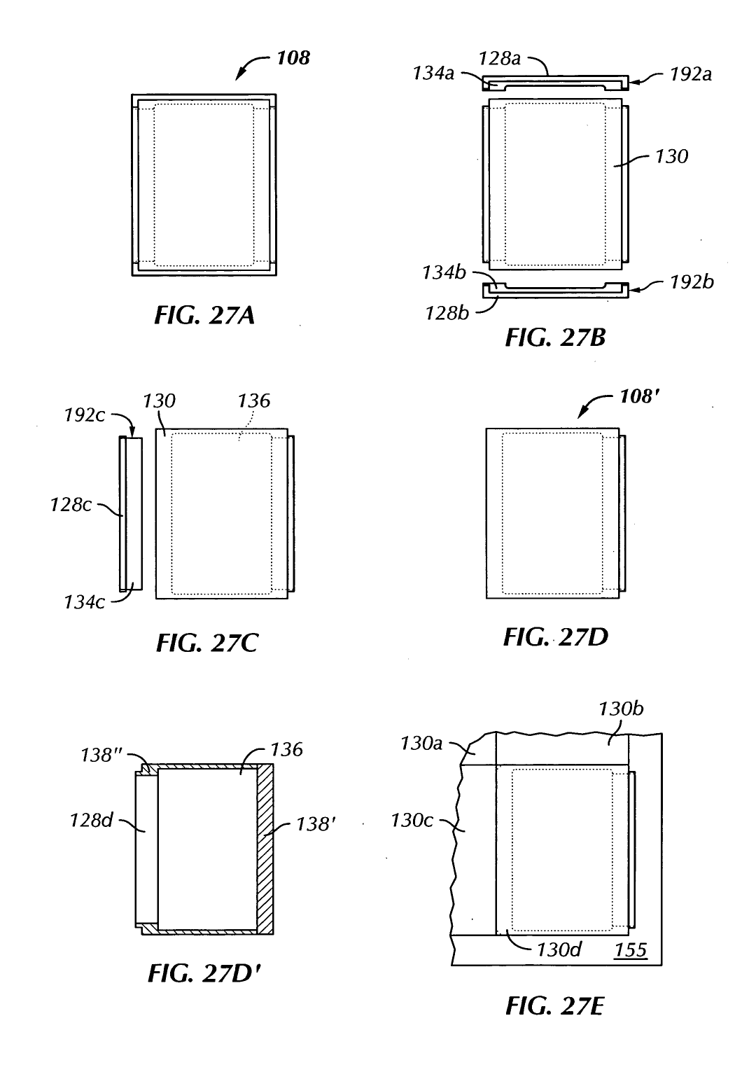

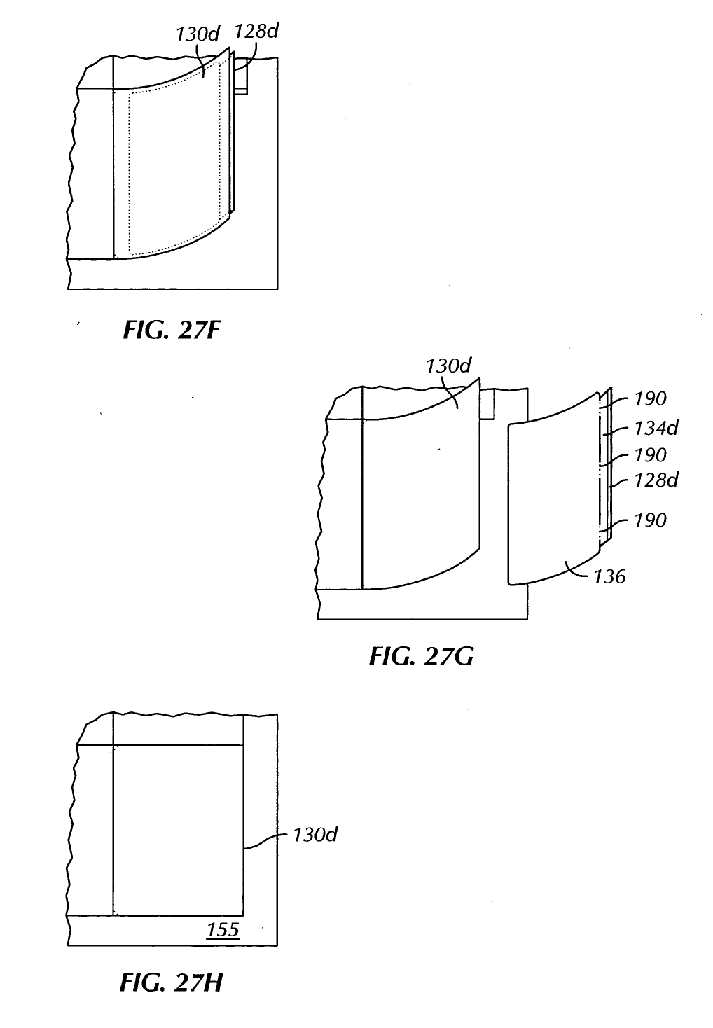

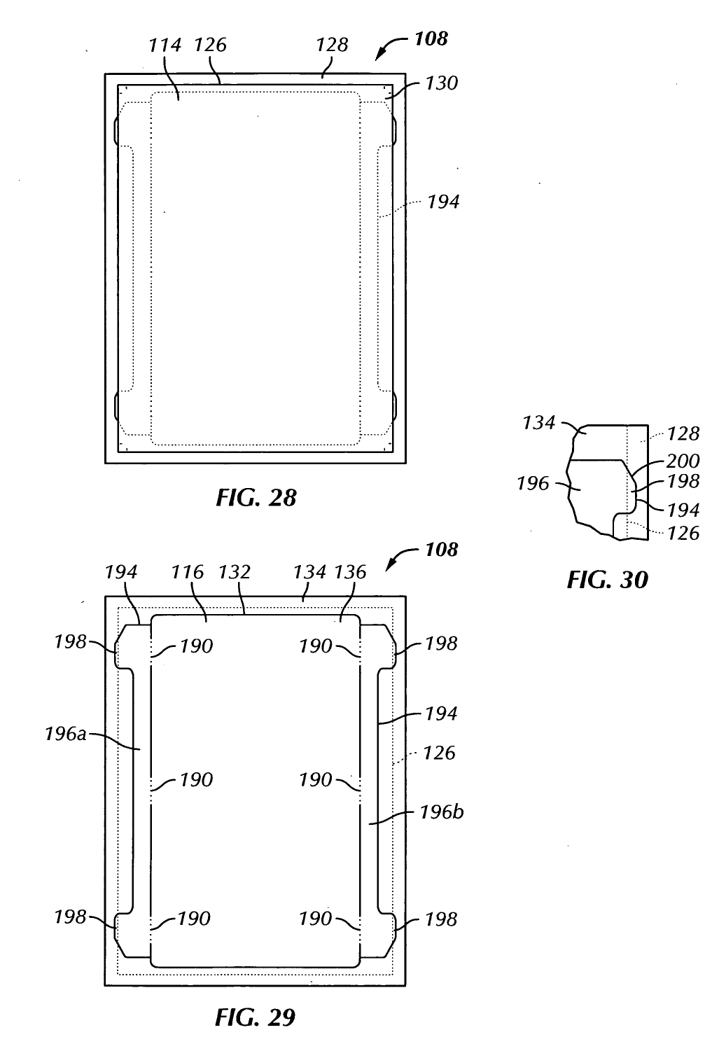

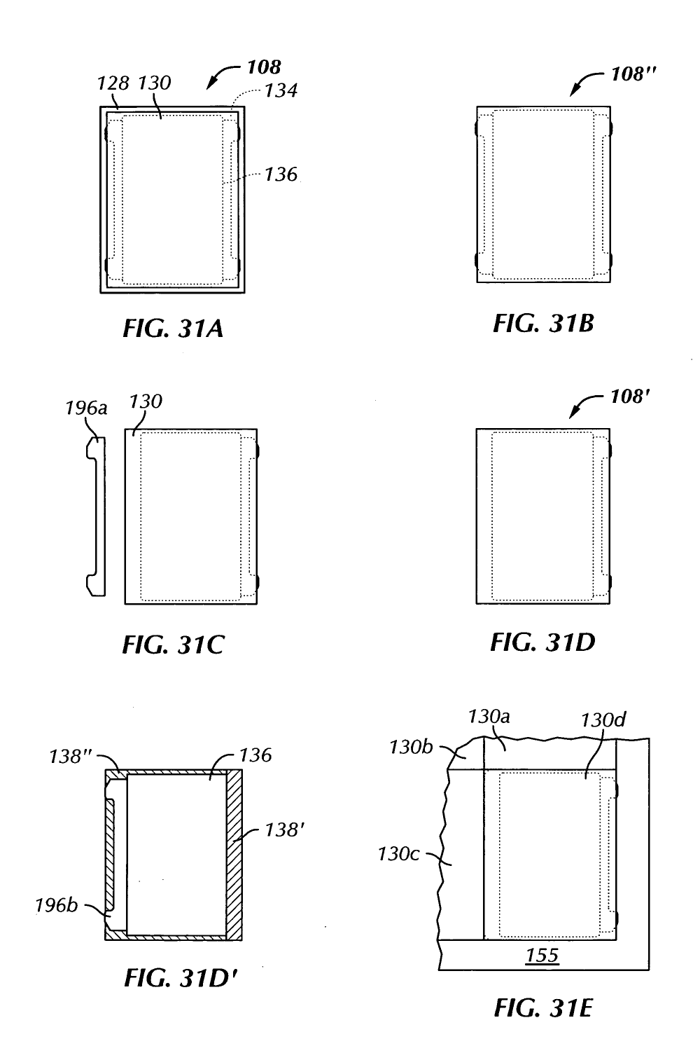

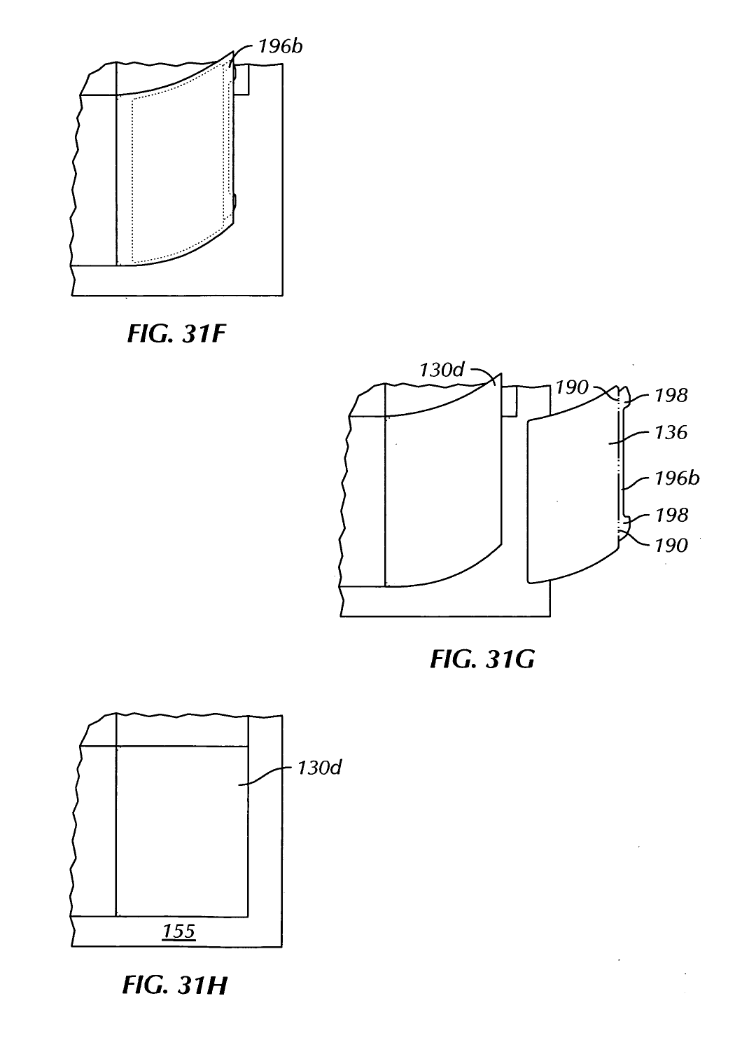

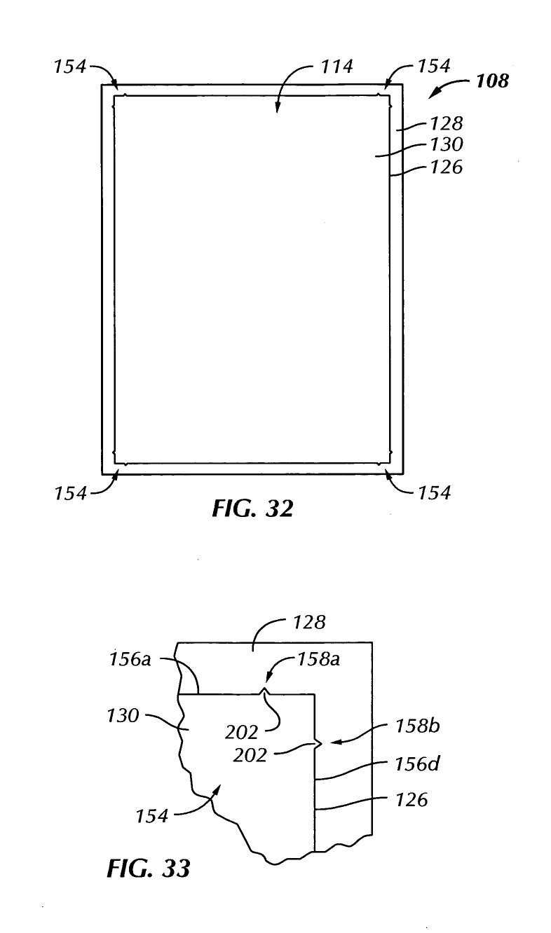

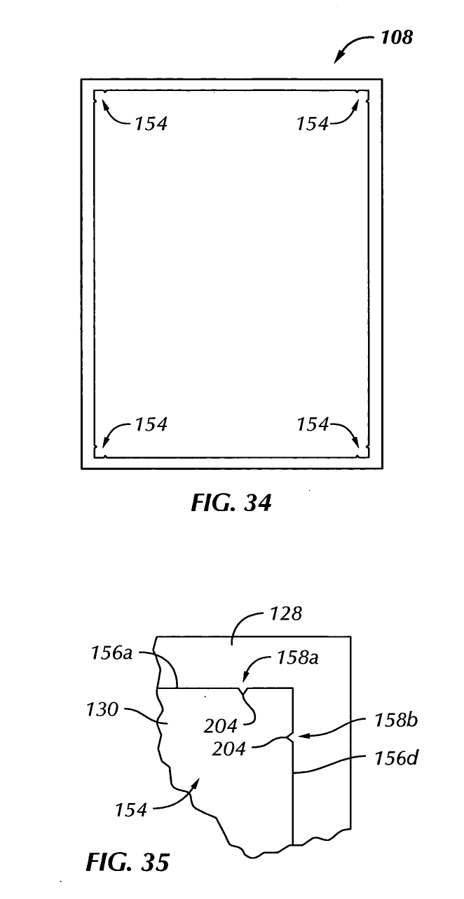

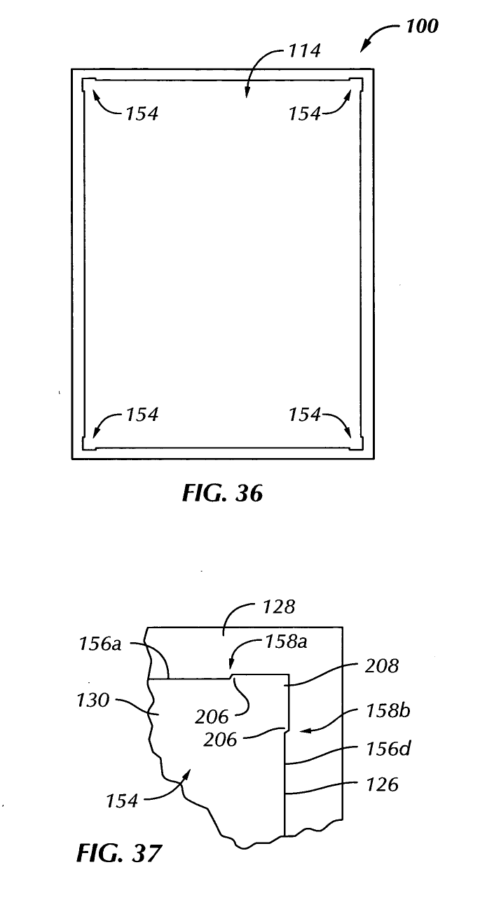

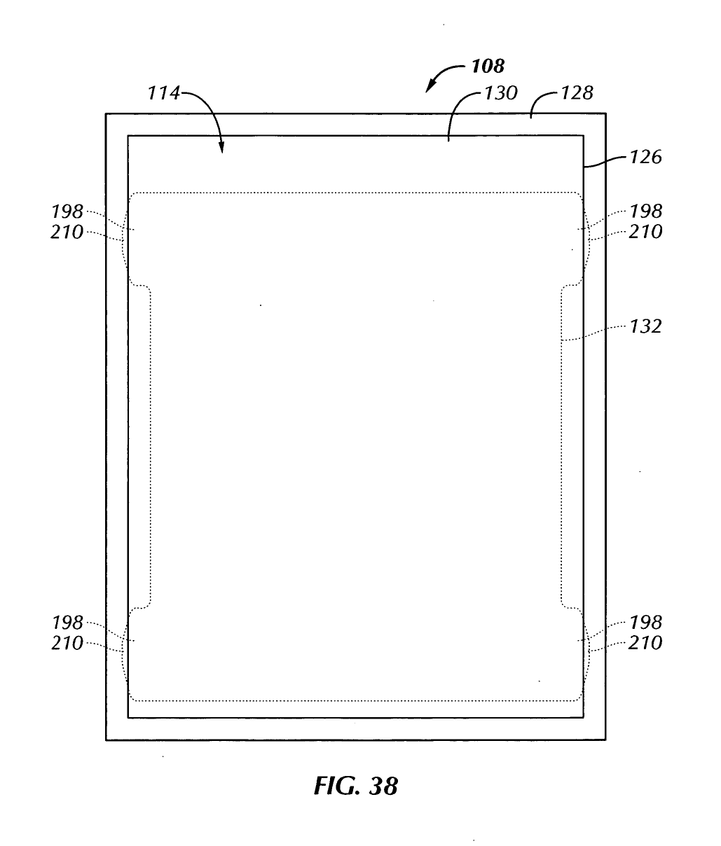

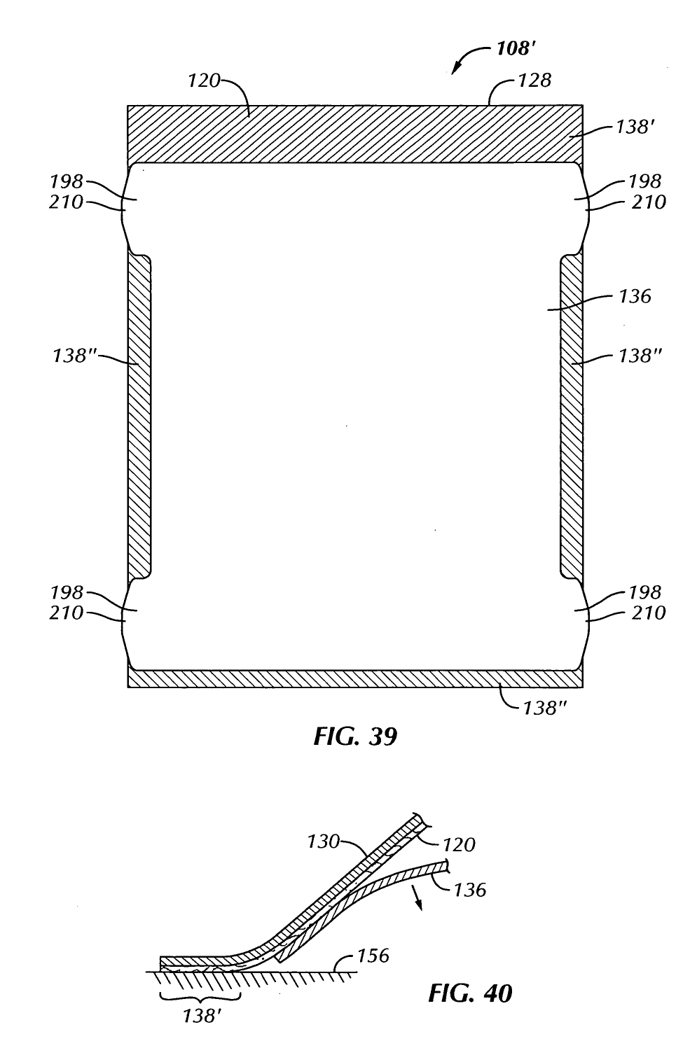

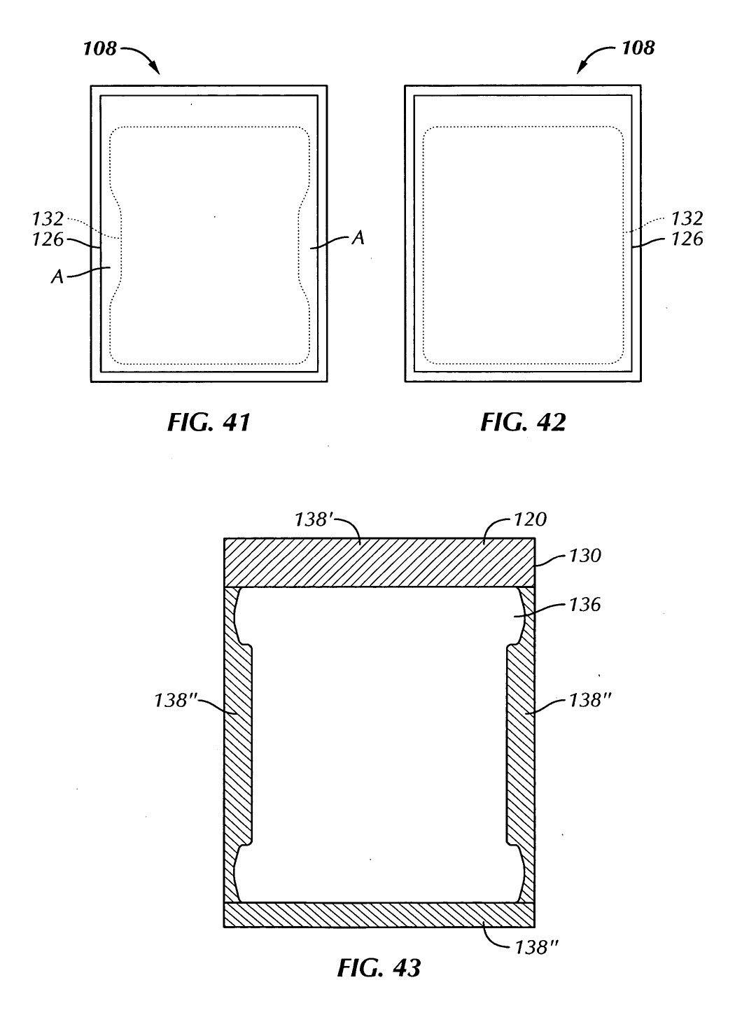

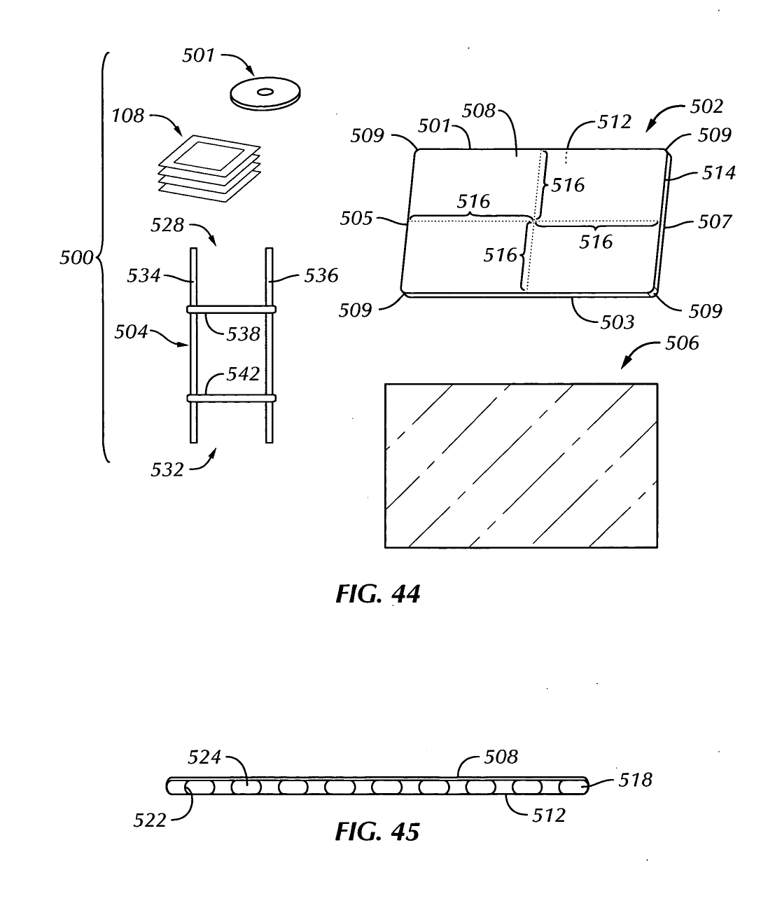

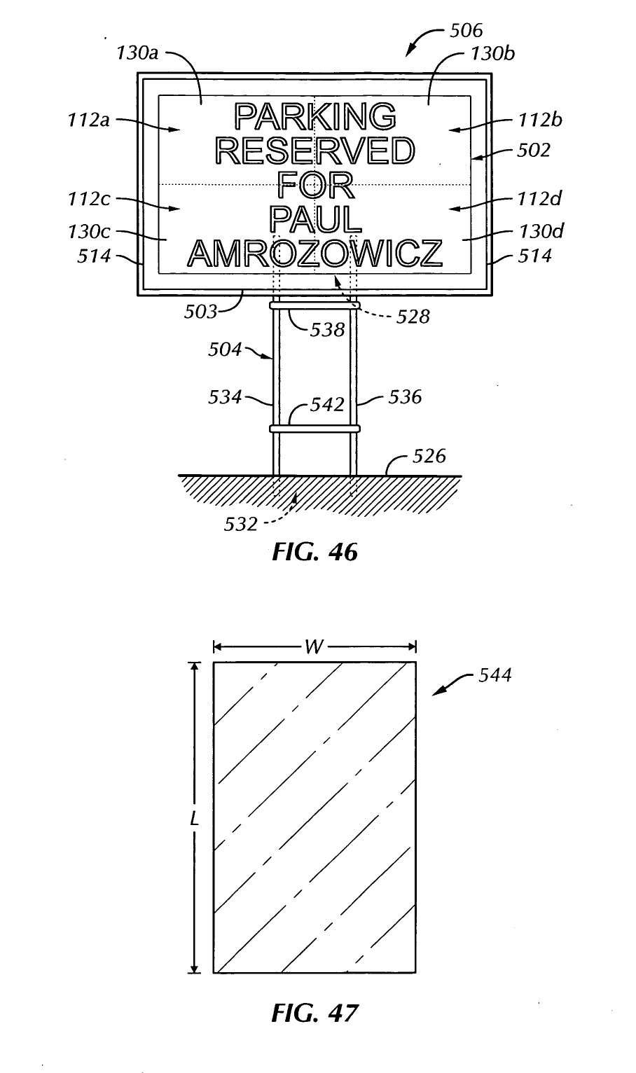

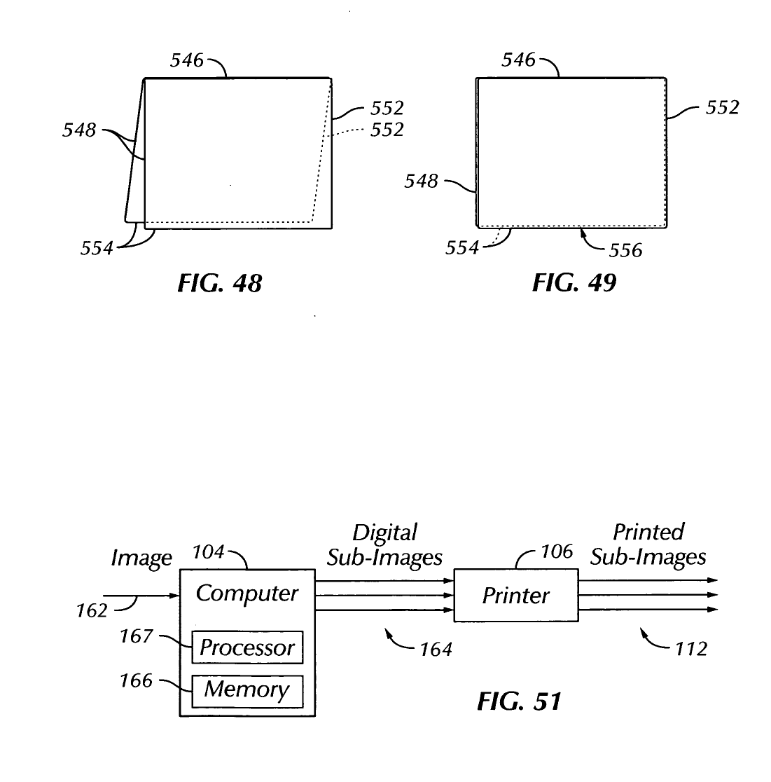

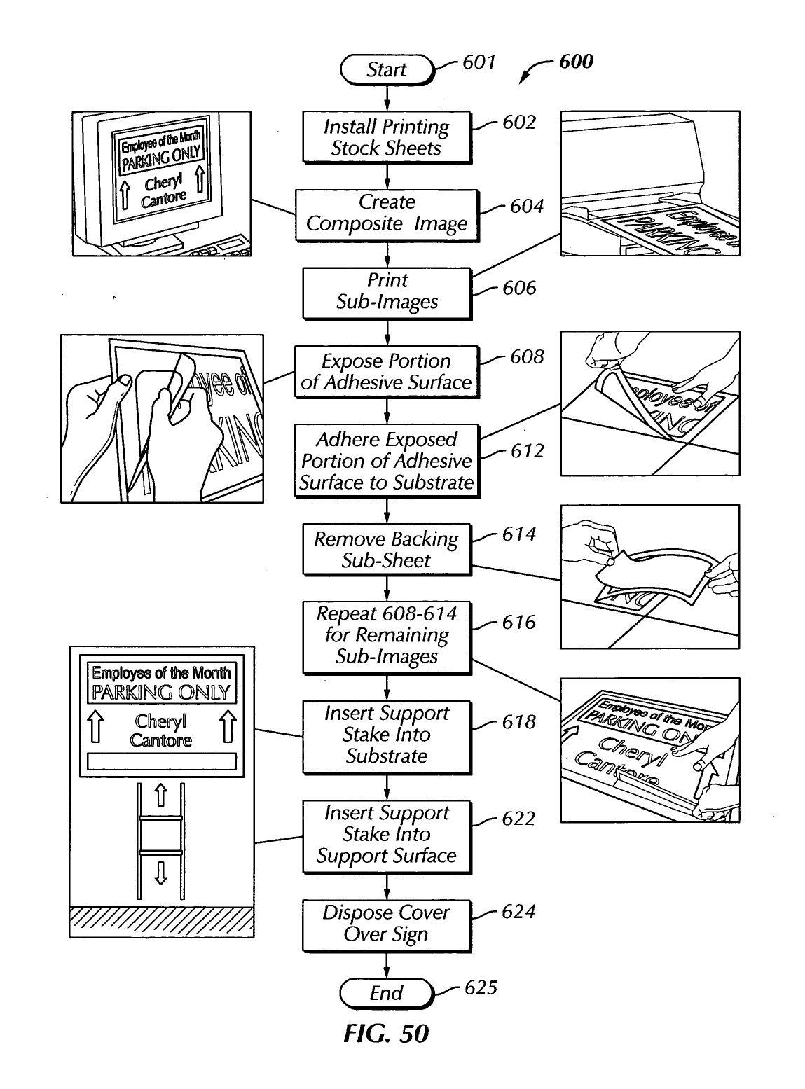

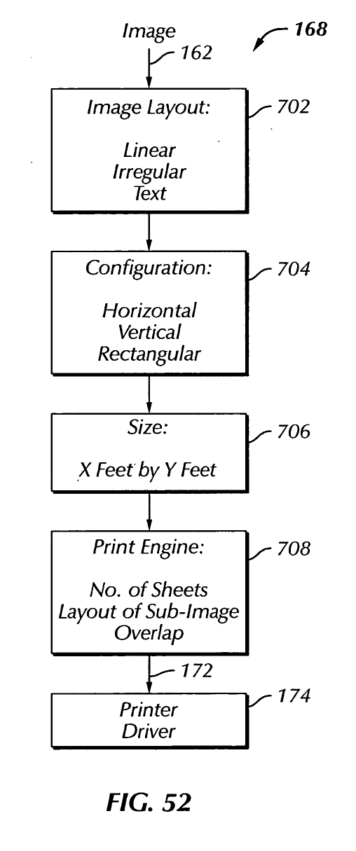

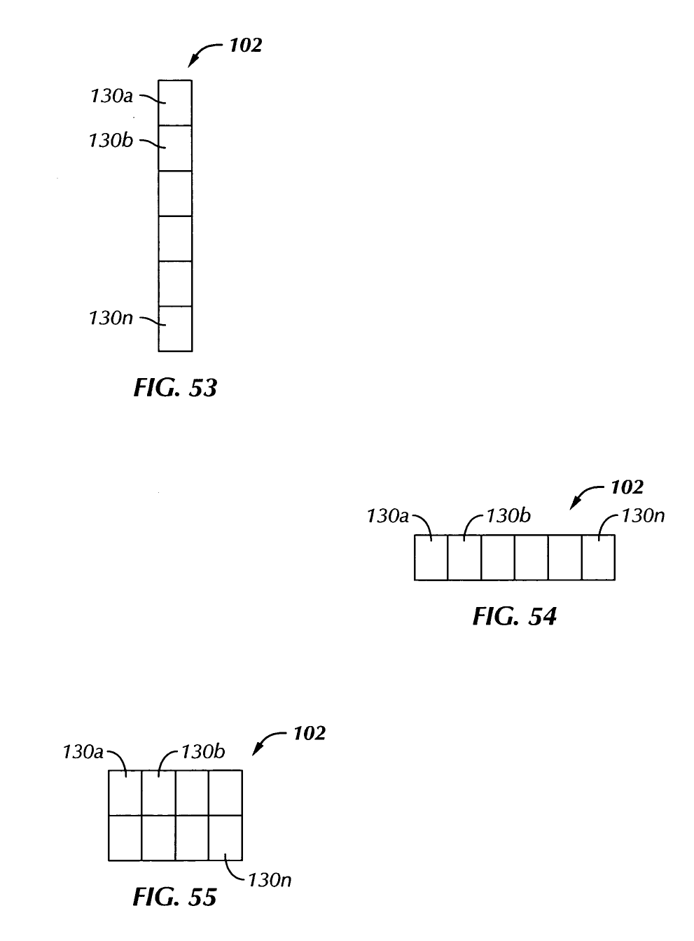

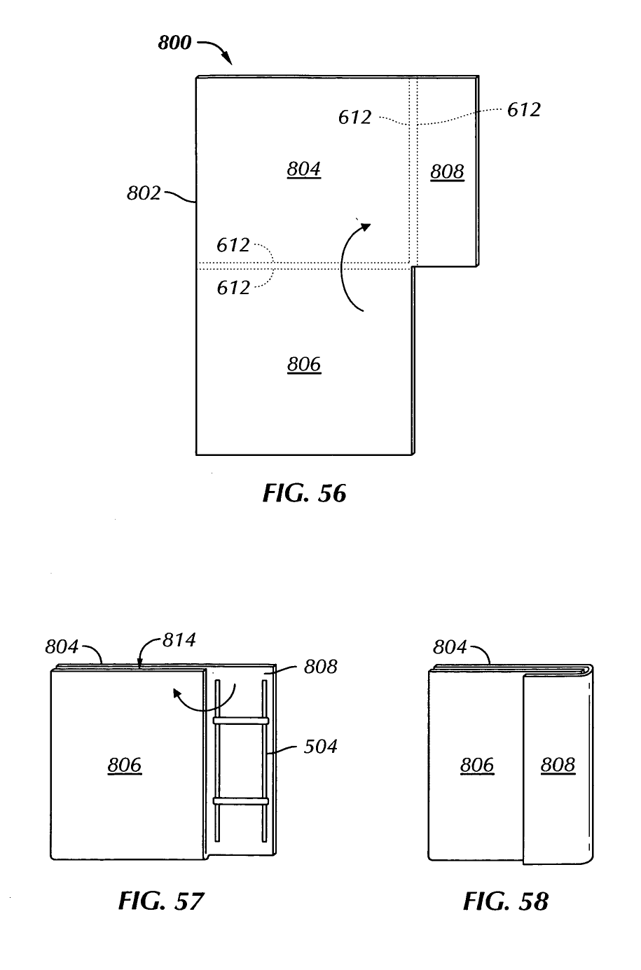

With continued reference to FIGS. 25 and 26, and additional reference to FIGS. 27A to 27H, after a sub-image 112 (not shown in FIG. 27A; see, e.g., FIG. 3) has been printed on the sheet 108, the top and bottom section 192a and 192b may be removed by, for example, peeling the sections 192 rearward and away from the face sub-sheet 130, as shown in FIG. 27B. One of the side sections 192c or 192d, e.g., the left side section 192c, may then be removed as shown in FIG. 27C, for example, by holding the face sub-sheet 130 and the backing sub-sheet 136 together while pulling the side section 192 away and breaking the perforated sections 190, thereby yielding a readily adherent sheet 108′ as shown in FIG. 27D.

As shown in FIG. 27D′, with the removal of the left side sections 192c, the readily adherent sheet 108′ includes a relatively large exposed adhesive portion 138′ indicated by cross hatching. And with the removal of the top and bottom sections 192a and 192b, the readily adherent sheet 108′ includes a relatively small exposed adhesive portion 138″ indicated by contrasting cross hatching.

As shown in FIG. 27E, the readily adherent sheet 108′ may then be adhered to a surface 155. If other face sub-sheets 130 have already been adhered to the surface 155 (e.g., face sub-sheets 130a, 130b, and 130c as shown in FIG. 27E), then the readily adherent sheet 108′ may be aligned therewith as described above, e.g. by overlapping face sub-sheet 130d onto the already positioned face sub-sheets 130b and 130c. The face sub-sheet 130d may then be adjusted in position if needed to correct for mis-registration in the image or graphics printed thereof.

One of the sides, e.g., the left side, which is shown as including the relatively large exposed adhesive portion 138′, may then be pressed down against the surface 155 and any adjoining face sub-sheets 130. The other side, e.g., the right side, may then be curled toward the adhered side as shown in FIG. 27F. Because of the relatively small exposed adhesive portions 138″, the face sub-sheet 130d peels relatively easily away from the surface 155 and any adjacent adhered face sub-sheets, while the portion of the face sub-sheet 130d corresponding to the relatively large exposed adhesive portion 138′ remains adhered. The remaining border, e.g., the right border 128d as shown, may then be peeled away from the face sub-sheet 130d. In embodiments with the perforated sections 190, the peeling of the right border 128d will also peel the backing sub-sheet 136 away as well because of the attachment provided by the perforated sections 190, as shown in FIG. 27G. The face sub-sheet 103d may then be adhered to the surface 155, as shown in FIG. 27H.

Further embodiments of a sheet 108 of printing stock are illustrated in FIGS. 28 and 29. In these embodiments, a face sheet 114 may have a face cut 126 defining a margin 128 and a face sub-sheet 130. A backing sheet 116 may have a primary backing cut 132 defining a border 134 and a backing sub-sheet 136. In addition, the backing sheet 116 includes one or more secondary backing cuts 194 extending from the primary backing cut 132 into the border 134, thereby forming one or more border sections 196, for example a left border section 196a and a right border section 196b. The secondary backing cuts 194 may also define one or more tab sections 198 of the border sections 196 at locations at which the secondary backing cuts 194 extend spatially beyond the face cut 126 and are juxtaposed over the margin 128 of the face sheet 114, as particularly shown in FIG. 30. In some of the embodiments, the secondary backing cuts 194 includes an angled section 200 spatially positioned over the face cut 126 for facilitating a non-tearing separation of the tab sections 198 from the adhesive surface 120 of the face sheet 114, which is discussed in more detail below.

With continued reference to FIGS. 28 and 29, and with additional reference to FIGS. 31A to 31H, after a sub-image 112 (not shown in FIG. 31A; see, e.g., FIG. 3) has been printed on the sheet 108, the margin 128 and the board 128 may be may be separated from the face sub-sheet 130 and the backing sub-sheet 136, thereby yielding a modified sheet 108″, as shown in FIG. 31B. Either one of the border sections 196, e.g., the left border section 196a as shown in FIG. 31C, may be removed by peeling the border section away from the face sub-sheet 130 and breaking the perforated sections 190 if present, thereby yielding a readily adherent sheet 108′ as shown in FIG. 31D.

As shown in FIG. 31E, the readily adherent sheet 108′ may then be adhered to a surface 155. If other face sub-sheets 130 have already been adhered to the surface 155 (e.g., face sub-sheets 130a, 130b, and 130c as shown in FIG. 31E), then the readily adherent sheet 108′ may be aligned therewith as described above. One of the sides, e.g., the left side as shown, may then be pressed down against the surface 155 and any adjoining face sub-sheets 130. The other side, e.g., the right side, may then be curled toward the adhered side as shown in FIG. 31F.

As shown in FIG. 31D′, with the removal of the left border section 196a, the readily adherent sheet 108′ includes a relatively large exposed adhesive portion 138′ indicated by cross hatching. And with the removal of the margin 128 and the border 134, the readily adherent sheet 108′ includes a relatively small exposed adhesive portion 138″ indicated by contrasting cross hatching.

The remaining border, e.g., the right border section 196b as shown, may then be peeled away from the face sub-sheet 130d. Because of the relatively small exposed adhesive portions 138″, the face sub-sheet 130d peels relatively easily away from the surface 155 and any adjacent adhered face sub-sheets, while the portion of the face sub-sheet 130d corresponding to the relatively large exposed adhesive portion 138′ remains adhered. The tab sections 198 provide a surface on which to grasp to facilitate the peeling. The angled section 200 at the tab section 194 facilitates a smooth peeling action at that location. In embodiments with the perforated sections 190, the peeling of the right border section 196b will also peel the backing sub-sheet 136 away as well because of the attachment provided by the perforated sections 190, as shown in FIG. 31G. The face sub-sheet 103d may then be adhered to the surface 155, as shown in FIG. 31H.

Reference is now made to FIGS. 32 to 37 which respectively illustrate examples of additional embodiments of printing stock 108 and, more particularly, to embodiments of printing stock 108 with different examples of registration marks 154. In the embodiments shown in FIGS. 32 and 33, the registration marks 154 includes one or more alignment elements 158 that are formed in the face sheet 114 as tabs 202 that protrude outwardly from the edges 156 of the face sub-sheet 130. In other words, the alignment elements 158 may be described as discontinuities in the face cut 126 located at predetermined positions, such as less than an inch or so from a corner of the face sub-sheet 130 (e.g., about three eighths of an inch). Accordingly, the alignment elements 158 may be made at the same time or during the same production step as the face cut 126. In alternative embodiments, as represented in FIGS. 34 and 35, the alignment marks 158 may be formed in the face sheet 114 as notches 204 that protrude inwardly into the face sub-sheet 130 from the edges 156 thereof.

Other examples of the registration marks 154 are represented by the embodiments of FIGS. 36 and 37. In these embodiments, the alignment elements 158 may be formed in the face sheet 114 as angled cuts 206 that either project inwardly from the edges 156 of the face sub-sheet 130 or outwardly as shown. Accordingly, the angled cuts 206 define discontinuities in the face cut 126 and define an enlarged corner 208 of the face sub-sheet 130. Like the embodiments described above, as the angled cuts 206 define a section of the face cut 126, the registration marks 154 of these embodiments may be made during production at the time the face sheet 114 is cut into the face sub-sheet 130 and margin 128. Regardless of the embodiment, the registration marks 154 enable a face sub-sheet 130 that is to be subsequently positioned to be overlapped on top of an already positioned face sub-sheet 130, and then to be moved to make adjustments as needed to more properly align the image 112 to compensate for mis-registration or skewing.

Reference is now made to FIGS. 38 and 38 in which are illustrated further embodiments of a sheet 108 of printing stock. In these embodiments, a face sheet 114 may have a face cut 126 defining a margin 128 and a face sub-sheet 130. A backing sheet 116 may have a backing cut 132 defining a border 134 and a backing sub-sheet 136. As shown, one or more sections of the backing cut 132 may extend outwardly to form one or more tab sections 198. Each tab section 198 may extend spatially beyond the face cut 126 to define an overlay 210 that is juxtaposed over the margin 128 of the face sheet 114.

In a number of embodiments, the backing cut 132 may be set apart spatially a relatively greater distance from one of the sides of the face cut 126 (in the example shown, a top side of the face cut 126). Accordingly, with the removal of the face sub-sheet 130 along with the backing sub-sheet 136 (i.e., the readily adherent sheet 108′), as shown in FIG. 39, a relatively large exposed adhesive portion 138′ may be defined along one of the sides or edges of the readily adherent sheet 108′, while relatively small exposed adhesive portions 138″ may be defined along the other sides or edges.

With reference to FIG. 40, when positioned in a desired location on a surface 156 (see also, e.g., FIGS. 27E and 27F), the relatively large exposed adhesive portion 138′ may be pressed down against the surface 156 to retain the readily adherent sheet 108′ in place. The remainder of the sheet 108′ may then be lifted up to remove the backing sub-sheet 136, with the face sub-sheet 130 thereafter being pressed and adhered to the surface 156.

Alternatively, embodiments of sheets 108 of printing stock are illustrated in FIGS. 41 and 42. Similar to the embodiment shown in FIG. 44, the backing cut 132 may set apart spatially a relatively greater distance from one of the sides of the face cut 126. In contrast to the prior embodiments, the backing cut 132 may be spatially contained within the face cut 126, i.e., there are not overlays 210 (see FIGS. 38 and 39). The backing cut 132 includes indentations to provide an increased width of the border 134, indicated with an “A” in FIG. 41 or, alternatively, may be substantially rectangular or rectilinear in shape as shown in FIG. 42. In either embodiment, when the readily adherent sheet 108′ is removed, as shown in FIG. 43, a relatively large exposed adhesive portion 138′ may be defined along one of the sides or edges of the readily adherent sheet 108′ (represented by cross hatching), while relatively small exposed adhesive portions 138″ may be defined along the other sides or edges (represented by opposing cross hatching).

As noted above, the sheets 108 are preferably used to make a sign 102, such as the one illustrated in FIG. 2. In a preferred embodiment, the sign 102 is made using a kit 500, such as the one shown in FIG. 44. The kit 500, at least in the depicted embodiment, includes a plurality of the printing stock sheets 108, a software loaded CD-ROM 501, a substrate 502, a ground stake 504, and a cover 506. The printing stock sheets 108 may be any one of the various printing stock embodiments described above, or various combinations thereof. As various embodiments of the printing stock sheets 108 have already been fully described, further description thereof is not needed and will therefore not be further provided.

The substrate 502 includes a first surface 508, a second surface 512, and an outer peripheral edge 514 that is disposed between the first and second surfaces 508, 512. The first and second surfaces 508, 512 are preferably substantially planar, and at least one, but preferably both surfaces 508, 512, are adapted to have a plurality of face sheets 130 mounted thereon, preferably via the adhesive surfaces 120. Preferably, the surfaces 508, 512 are releasably adherent with the adhesive surface 120 of the face sheets 130, so that the substrate 502 may be reused, as desired, for other signs. It will be appreciated that this is merely exemplary, and that in other embodiments one or both surfaces 508, 512 could instead have a releasably adherent adhesive disposed thereon. It yet other embodiments, the adhesive, on either or both the adhesive backed surfaces 120 and one or both of the surfaces 508, 512 could have permanent adhesive applied thereto.

The substrate 502 may be formed of any one of numerous types of materials and may be formed in any one of numerous shapes. In the depicted embodiment, the substrate 502 is formed of a polymer material, and is substantially rectangular in shape, having a top side 501, a bottom side 503, a left side 505, a right side 507, and four corners 509. The choice of polymer material may vary, but the material is preferably chosen to provide sufficient weather resistance, and so that the face sheet adhesive surface 120 will be releasably adhered thereto. The first and second surfaces 508, 512 are substantially flat, though each could include minor irregularities, and provide a mount surface to which a plurality of the face sheets 130 may be releasably adhered. The first and second surfaces 508, 512 additionally have a plurality of alignment indicia 516 disposed thereon that are arranged to facilitate alignment of the plurality of face sheets 130 on the substrate surfaces 508, 512. The alignment indicia 516 may be implemented according to any one of numerous configurations. For example, various sizes and shapes of markings could be included on the substrate surfaces 508, 512. However, in the depicted embodiment the alignment indicia 516 are implemented as a plurality of cuts in the substrate surfaces 508, 512. Preferably, the alignment indicia 516 are included on both substrate surfaces 508, 512. It will be appreciated, however, that the substrate 502 could be implemented with the alignment indicia 516 included on only one of the substrate surfaces 508 or 512.

Turning now to FIG. 45, it is seen that a slotted layer 518 is disposed between the first and second substrate surfaces 508, 512. The slotted layer 518 includes a plurality of longitudinally extending slots 522 that, together with the first and second surfaces 508, 512, form a plurality of openings 524. At least some of the openings 524 are exposed along at least a portion of the substrate outer peripheral edge 514. More specifically, at least in the depicted embodiment, the openings 524 are exposed along the entire extent of the top and bottom sides 501, 503, and each opening extends between the top and bottom sides 501, 503. As will be described more fully below, the exposed openings 524 snugly receive a portion of the support stake 504. It will be appreciated that the slotted layer 518 is merely exemplary of a particular embodiment, and that the slots 522 could instead be formed by disposing a corrugation layer between the first and second substrate surfaces 508, 512, and that the openings 524 could be formed using any one of numerous techniques or configurations.

The support stake 504 is used to support the substrate 502 above a suitable support surface 526, and includes a first end 528 and a second end 532. With reference now to FIG. 46, it is seen that the first end 528 is inserted, via the substrate outer peripheral edge 514, into the substrate 502, and the second end 532 is inserted into the support surface 526. It will be appreciated that the support stake 504 may be implemented using any one of numerous configurations, but in the depicted embodiment the support stake 504 includes first and second support legs 534, 536 and first and second cross members 538, 542. The support legs 534, 536 are spaced apart a suitable distance, which may vary, so long as each is readily insertable into the substrate 502 via one of the exposed openings 524 in the substrate outer peripheral edge 514. Preferably, one end of the supports legs 534, 536 are inserted into the substrate 502 to a fully inserted position. In the fully inserted position, which is the position shown in FIG. 46, the first cross member 538 contacts the substrate outer peripheral edge 514 and provides additional support for the substrate 502. It will be appreciated, however, that the support legs 534, 536 could be inserted to any one of numerous other positions between the fully removed position and the fully inserted position. The other ends of the support legs 534, 536, as was previously mentioned, are inserted into a suitable support surface 526 such as, for example, the ground. Depending on the consistency and hardness of the ground 526, the support stake 504 may be inserted into the ground 526 by applying pressure with one or two hands. Alternatively, a user may apply pressure to the second cross member 542 using, for example, one foot or both feet.

If the sign 102 is positioned outdoors it may be exposed to various environmental elements including, for example, rain, snow, dew, or other forms of environmental moisture. Thus, to help protect the sign 102 against such environmental moisture, the cover 506 may be disposed over the sign 102. The cover 506 may be formed of any one of numerous types of materials, but in a particular preferred embodiment the cover 506 is formed of a substantially transparent material that is substantially impervious to moisture. For example, in the depicted embodiment the cover 506 is formed of substantially transparent plastic. The cover 506 may additionally be implemented according to any one of numerous configurations, but in the depicted embodiment the cover 506 is configured as an enclosure that is shaped substantially identical to, but is slightly larger in surface area than, the substrate first and second surfaces 508, 512. Thus, in the depicted embodiment, in which the substrate 502 is rectangular in shape, the cover 506 is also substantially rectangular in shape.

Although the cover 506 may be formed using any one of numerous techniques, in the depicted embodiment, and as shown more clearly in FIGS. 47-49, it is formed from a single transparent plastic sheet 544 having a width (W) that is slightly wider than the width of the substrate 502, and a length (L) that is slightly greater than twice the height of the substrate 502. The transparent plastic sheet 544 is folded substantially in half along its width to form a closed end 546 along the fold. After it is folded, three edge pairs 548, 552, 554 are also formed. Two of the edge pairs 548, 552 are then sealed, while the remaining edge pair 554, which is disposed opposite the closed end 546, is left unsealed to define an opening 556 that is slightly wider than the width of the substrate 502.

Returning once again to FIG. 46, the cover 506 is slidably disposed over the substrate 502 via the opening 556. The cover 506 is preferably dimensioned such that when it is disposed over the substrate 502, the edge pair 554 that forms the opening 556 is either coextensive with the substrate bottom side 503 or extends just slightly below the substrate bottom side 503. With this configuration, the substrate 502 will substantially prevent the edge pair 554 that forms the opening 556 from sticking together in the presence of moisture. It has been found that if the cover 506 extends too far below the substrate bottom side 503, moisture can get inside the cover 506, near the opening 556, and cause the edge pair 554 to stick together. As a result, the moisture may wick up the inside of the cover 506 and potentially damage the sign 102 by, for example, causing the portions of the printed composite image 110 to bleed or run. It will be appreciated that other configurations or devices could be used to prevent or inhibit moisture infiltration. For example, tape or other types of fasteners, seals, or adhesives could be used. Moreover, a spacer, such as a rod, could be inserted into the cover 506 to hold the opening slightly open. As FIG. 46 also shows, because the cover 506 is dimensioned such that the width of the opening 556 is only slightly larger than the width of the substrate 502, the substrate corners 509 are rounded. The rounded corners 509 facilitate disposal of the cover 506 over the substrate 502. Although all four corners 509 are depicted as being rounded, it will be appreciated that the substrate 502 could be implemented such that only two of the corners 509 are rounded.

Referring now to FIG. 50, a particular preferred process 600 for assembling the sign 102 will be described. Initially, the process includes installing a plurality of sheets 108 of printing stock into a conventional SOHO printer (602). The user then selects or creates a desired composite image 110 for the sign 102 using, for example, the user interface 170 and software that is loaded onto the computer 104 (604). In this regard, before proceeding further with the description of the preferred assembly process 600, a more detailed description of the software and its implementation on the computer 104 will first be provided.

With reference now to FIG. 51, the software is preferably loaded onto and executed by the computer 104. More specifically, the software is preferably loaded into a memory 166, and is preferably executed by a processor 167. The software may processes the desired composite image 162 to generate one or more sets of digital sub-images 164 that are subsequently used to form the sign 102. More specifically, as shown in FIG. 52, the software 168 preferably processes the desired composite image 162 to determine a layout of the final composite image 110 (702). For example, the layout of the final composite image 110 may be characterized as being linear (e.g., horizontally or vertically), irregular (e.g., square, circular, or triangular), or text only. It is noted that for the purposes of this description, the word “image” is used to indicate any type of output that may be printed on the printing stock sheets 108, including images, graphics, text, or any combination thereof. Accordingly, if the desired composite image 162 contains only text, then the software engine 168 may determine that the desired composite image 162 is linear (e.g., no wrapping of text) or rectangular (e.g., wrapping of text).

The software engine 168 also processes the desired composite image 162 to determine a configuration of the image (704). For example, the configuration of the desired composite image 110 may be characterized as being horizontal (e.g., unwrapped text), vertical, or rectangular. If the final composite image 110 is characterized by verticality, then the software engine 168 may determine that the plurality of face sub-sheets 130 with the printed sub-images 112 should be arranged in a vertical pattern as shown in FIG. 53 to form the sign 102. Further, if the desired composite image 162 is characterized by horizontality, then the software engine 168 may determine that the plurality of face sub-sheets 130 with the printed sub-images 112 should be arranged in a horizontal pattern as shown in FIG. 54 to form the sign 102. In addition, if the desired composite image 162 is characterized by rectangularity, then the software engine 168 may determine that the plurality of face sub-sheets 130 with the printed sub-images 112 should be arranged in a rectangular pattern as shown in FIG. 55 to form the sign 102. In other embodiments, the software engine 168 may additionally process the desired composite image 162 in consideration of size (706). To do so, a user may enter a desired size such as, for example, x feet by y feet, into the computer 104, via the user interface 170.

The software engine 168 then utilizes the processed characteristics of the desired composite image 162 to determine one or more sets 172 of digital sub-images 164 that may be appropriately used to form the sign 102 in a print engine (708). For example, the software engine 168 may determine the number of printing stock sheets 108 that are needed to form the sign 102 with the desired composite image 162. In addition, the software engine 168 may determine a layout of each of the printed sub-images 112 on the face sheet 130 to achieve the final composite image 110. If more than one set 172 of digital sub-images will satisfactorily form the final composite image 110, then the software engine 168 may query a user through the interface 170 as to which exemplary set 172 to use. The selected or most appropriate set 172 of digital sub-images 164 may then be output to a print driver 174.

Preferably, the software 168 also determines an overlap in adjacent printed sub-images 112 so that when the face sub-sheets 130 are arranged in the predetermined pattern to form the sign 102, there will be no breaks in the composite final image 110. More specifically, as shown in FIG. 11, printed sub-image 112a of sheet 108a includes an overlap 176a along the side of sheet 108a that will be adjacent to or mated with sheet 108b′. Similarly, printed sub-image 112b of sheet 108b′ includes an overlap 176a along the side of sheet 108b′ that will be adjacent to or mated with sheet 108a. Accordingly, as shown in FIG. 12, when sheet 108b′ is adhered to sheet 108a, overlap 176b overlays and aligns with overlap 176a so that the resulting composite image 110 is complete and without breaks. The overlapping of the sheets 108 may compensate for and enable correct alignment when minor variations in print registration and minor skewing of the image or text are present on the sheets 108.

Returning once again to FIG. 50 and the description of the assembly process 600, once the composite image 110 has been designed, the user then prints the sub-images 112 on a respective plurality printing stock sheets 108 of (606). The user then exposes a portion (e.g., portion 138 in FIG. 4) of the adhesive surface 120 (608) by, for example, removing at least a portion of the border 134 of the backing sheet 116. Thereafter, using the alignment indicia 516 as a guide, the user forms the sign 102 by adhering the exposed portion 138 of the adhesive surface 120 of each imprinted sheet 108 to the appropriate portion of the substrate 502 (612) and then, when appropriately positioned, removing the backing sub-sheet 136 (314). The prior three steps (e.g., 608-614) are repeated, ensuring that appropriate portions of the printed sub-images 112 overlap, until the entire composite image 110 is disposed on the substrate 502, thereby completing the sign 102 (616). It will be appreciated that in embodiments where the face sheets 130 include registration marks 154, the user may align the face sheet 130 with the exposed portion 138 of the adhesive surface 120 with the registration marks 154 and the printed image or text of another one of the printed sheets 108 of printing stock.

Once the sign 102 is completed, or at any point before its completion, the support stake 504 may be inserted into the substrate 502 via the openings 524 in the substrate bottom side 503 (618). The support stake 504 may then be inserted into the support surface 526 (622). If the sign 102 is to be placed outdoors, or in an environment in which it will potentially be exposed to moisture, the cover 506 is preferably disposed over the sign 102 (624). It will be appreciated that the cover 506 may be disposed over the sign 102 either before or after the support stake 504 is inserted into the substrate 502 and/or before or after the support stake 504 is inserted into the support surface 526.

In addition to providing a unique sign kit 500, which is used to make a unique sign 102, the sign kit 500 is preferably provided in a unique package. More specifically, and with reference now to FIGS. 56-58, an embodiment of a package 800 for the sign kit is shown. The package 800 is preferably formed from a single corrugated cardboard sheet 802 that includes a back section 804, a front section 806, and a fold section 808. The cardboard sheet 802 is dimensioned such that the back section 804 and front section 806 have substantially equal heights and widths, and such that the back section 804 and the fold section 808 have substantially equal heights. However, the width of the fold section 808 is substantially less than the width of the back section 804.

The cardboard sheet 802 additionally has a plurality of perforations 812 formed therein between the back 804 and front 806 sections, and between the back 804 and fold 808 sections. The perforations 812 allow the back section 804 and front section 806, and the back section 804 and fold section 808, to be folded relative to one another to form the package 800. For example, as shown in FIG. 57, when the front section 806 is folded toward the back section 804, a receptacle 814 is defined in which a plurality of the sheets 108, the substrate 502, the cover 506, and various other items, such as the software, and written and illustrated directions, may be inserted. As FIG. 57 also shows, the fold section 808 provides a mount surface 816 on which the support stake 504 may be mounted. Thereafter, as shown in FIG. 58, when the fold section 808 is folded inward over the front section 806, a unique and compact package 800 is formed. While not illustrated, the package 800 is preferably encapsulated in a suitable transparent plastic film to ensure the contents thereof remain within the package 800.

What is claimed is:

1. A sign comprising:
a substrate having a first side, a second side, and an outer peripheral edge between the first and second sides, the substrate adapted to have a plurality of printable sheets adhesively and removably mounted thereon;
alignment indicia disposed on at least the substrate first side, the alignment indicia arranged to facilitate alignment of the plurality of adhesive backed sheets on the substrate first surface; and
a support stake having a first end and a second end, the support stake first end attached to the substrate, the support stake second end configured to insert into a support surface.

2. The sign of claim 1, further comprising:
a substantially transparent cover removably disposed over the substrate.

3. The sign of claim 2, wherein the substantially transparent cover is substantially waterproof.

4. The sign of claim 1, wherein:
the substrate outer peripheral edge defines a substrate top, a substrate bottom, a substrate left side, and a substrate right side, and at least two corners between the substrate top and the substrate left and right sides; and
the corners are rounded.

5. The sign of claim 1, wherein the support stake comprises:
two longitudinally extending and coextensive legs spaced apart from each other, each leg having opposing ends; and
two spaced apart cross members coupled to each leg between the opposing ends of each leg.

6. The sign of claim 5, wherein:
the substrate outer peripheral edge has a plurality of openings formed therein; and
each leg has a cross sectional area dimensioned to snugly fit within one of the openings.

7. The sign of claim 1, wherein the support stake first end is inserted into the substrate via the substrate outer peripheral edge.

8. A sign comprising:
a substrate having a first substantially planar surface, a second substantially planar surface, and an outer peripheral edge between the first and second substantially planar surfaces, at least the substrate first substantially planar surface adapted to have a plurality of printable sheets adhesively and removably mounted thereon, the substrate outer peripheral edge defining at least a substrate top, a substrate bottom, a substrate left side, a substrate right side, and at least two rounded corners between the substrate top and the substrate left and right sides;
a support stake having a first end and a second end, the support stake first end inserted into the substrate via the substrate bottom, the support stake second end adapted to insert into a support surface; and
a substantially transparent cover slidably disposed over and surrounding the substrate.

9. The sign of claim 8, further comprising:
alignment indicia disposed on at least the substrate first substantially planar surface, the alignment indicia arranged to facilitate alignment of the plurality of adhesive backed sheets on the substrate first substantially planar surface.

10. The sign of claim 8, wherein the substantially transparent cover is substantially waterproof.

11. The sign of claim 8, wherein the support stake comprises:
two longitudinally extending and coextensive legs spaced apart from each other, each leg having opposing ends; and
two spaced apart cross members coupled to each leg between the opposing ends of each leg.

12. The sign of claim 11, wherein:
the substrate bottom has a plurality of openings formed therein; and
each leg has a cross sectional area dimensioned to snugly fit within one of the openings.

13. A kit for making a sign, comprising:
a plurality of print stock sheets, each print stock sheet including a face sheet and a backing sheet, the face sheet having an image surface and a back surface, the image surface configured to have an image imprinted thereon, the back surface having a layer of adhesive applied thereto, and the backing sheet having a release coating adhered to the layer of adhesive.
a substrate having a first side, a second side, and an outer peripheral edge between the first and second sides, the substrate adapted to have one or more of the print stock sheets adhesively and removably mounted thereon;
alignment indicia disposed on at least the substrate first side, the alignment indicia arranged to facilitate alignment of each adhesive backed sheet mounted on the substrate first surface; and
a support stake having a first end and a second end, the support stake first end configured to be inserted into the substrate via the substrate outer peripheral edge, the support stake second end configured to insert into a support surface.

14. The kit of claim 13, further comprising:
a substantially transparent cover removably disposed over the substrate.

15. The kit of claim 14, wherein the substantially transparent cover is substantially waterproof.

16. The kit of claim 13, wherein:
the substrate outer peripheral edge defines a substrate top, a substrate bottom, a substrate left side, and a substrate right side, and at least two corners between the substrate top and the substrate left and right sides; and
the corners are rounded.

17. The kit of claim 13, wherein the support stake comprises:
two longitudinally extending and coextensive legs spaced apart from each other, each leg having opposing ends; and
two spaced apart cross members coupled to each leg between the opposing ends of each leg.

18. The kit of claim 17, wherein:
the substrate outer peripheral edge has a plurality of openings formed therein; and
each leg has a cross sectional area dimensioned to snugly fit within one of the openings.

19. The kit of claim 13, further comprising:
a package configured to hold therein at least the plurality of print stock sheets, the substrate, and the support stake, the package including:
a front section having an inner surface, an outer surface, a first end, and a second end;
a back section having an inner surface, an outer surface, a first end, and a second end, the back section first end coupled to the front section first end, the back section inner surface spaced apart from, and disposed substantially parallel to, the front section inner surface, to thereby form a receptacle between the front and back sections, the receptacle having a closed bottom, an open top, an open left side, and an open right side; and
a fold section coupled to, and coextensive with, the back section, the fold section folded over a portion of the front section, to thereby enclose one of the receptacle left side or receptacle right side.
